(19) United States
(12) Patent Application Publication
(10) Pub. No.: US 2022/0212700 A1
(43) Pub. Date: Jul. 7, 2022

(54) ADAPTIVE CODING, MODULATION, AND POWER CONTROL FOR POSITIVE TRAIN CONTROL SYSTEMS

(71) Applicant: Meteorcomm, LLC, Renton, WA (US)

(72) Inventors: Wipawee Siriwongpairat, Kent, WA (US); Thanongsak Himsoon, Kent, WA (US); Bo Wu, Seattle, WA (US); Jing Cai, Bellevue, WA (US)

(21) Appl. No.: 17/519,460

(22) Filed: Nov. 4, 2021

Related U.S. Application Data
(60) Provisional application No. 63/109,853, filed on Nov. 4, 2020.

(51) Int. Cl. B61L 27/20; H04W 52/26; H04W 52/24; B61L 15/00; B61L 27/70

(52) U.S. Cl. CPC B61L 27/20; H04W 52/262; H04W 52/241; B61L 2027/204; B61L 27/70; B61L 2205/00; B61L 2201/00; B61L 15/0027

(57) ABSTRACT

To improve throughput rates of packets transmitting positive train control (PTC) messages in an asynchronous wireless network that supports controlling movement of trains, data rates are adjusted based one or more conditions of the link. Modulation and coding schemes with less overhead can be employed to increase the data rate at which information is transferred when an estimated link quality or conditions are relatively good. Conversely, when the estimated link quality is relatively poor, more robust modulation and coding schemes for transmissions can be used to maintain link performance but at the cost of reduced data rates. Optionally, if the estimated link quality is higher than required to achieve a predefined maximum transmit rate at a given default power rate, transmit power can be reduced to that necessary for transmit at the predefined maximum transmit rate.

### RELATED APPLICATION

This application claims the benefit of U.S. Provisional Application No. 63/109,853, filed Nov. 4, 2020, which is incorporated by reference herein for all purposes.

### FIELD OF INVENTION

The invention relates to wireless radio data networks used with railroad control systems, particularly positive train control systems.

### BACKGROUND

Railroads in the United States and Canada have implemented centralized traffic control (CTC) systems that enable a dispatcher at a central office or central dispatch office to monitor and control interlockings and traffic flow within a designated territory. “Interlockings” refer generally to signaling arrangements that prevent conflicting train movements through junctions and crossings. A dispatcher, in some circumstances, can directly control the signal indications giving train movement authorities for a block of track. In addition, a dispatcher may sometimes need to be able to directly control switches that, for example, allow a train to move to a passing siding, crossover to an adjacent track, or turnout to an alternate track or route. A CTC system may also ensure that wayside devices or appliances, such as switches, are properly set before and during a train movement through a track block. In addition to receiving status information from signals and switches, the CTC system may also collect status information from other types of wayside devices, such as rail integrity/track circuits and hazard detectors.

A complex collection interconnected wired and wireless networks is typically relied on by a central office to communicate with wayside devices and trains. The wireless networks are usually spread over large geographic areas and comprised of radio base stations linked to each other and to central offices by communication links that are usually wired but are not necessarily limited to wired communications links. The base stations are used to established and maintain wireless communication links with locomotives, service vehicles, and wayside devices and systems operating within the coverage area for the base station.

A positive train control (PTC) system is intended to prevent train-to-train collisions, over-speed derailments, incursions into established work zone limits, and the movement of a train through a switch left in the wrong position. Like a CTC system, messages in a PTC system rely on wireless communication links to transmit messages between the functional subsystems used in controlling movement on railroads. The functional subsystems include wayside units such as crossing signals, switches, and interlocks: mobile units, such as locomotives and other equipment that travel on the railways, and their onboard controllers; and dispatch units located in central offices. Each functional subsystem consists of a collection of physical components comprising computers or other types of information processing equipment that are programmed to perform control processes, data storage components for storing databases and other information, and communication interfaces through which messages are exchanged.

A PTC system is “interoperable” if it allows locomotives of a host railroad and a tenant railroad to communicate with and respond to the PTC system, while supporting uninterrupted movements over property boundaries. Interoperability for PTC systems have been mandated for some railroads under the Rail Safety Improvement Act of 2008 (Public Law 110-432 of 2008). To support implementation of positive train control, the Class I freight railroads formed PTC-220 LLC to secure the 220 MHz spectrum as a data radio infrastructure to carry PTC data between base stations and wayside and mobile units.

Designing and operating a communications system for a transportation industry to support interoperability, particularly one as complex as the system of railroads in the United States, requires addressing many constraints. In the railroad industry, for example, a reliable and efficient communications system must be capable of handling different types of information, including data transmitted from the railroad central office and wayside systems to the locomotive on-board computers, as well as voice transmissions between train crews and the central office. Wireless communication systems supporting an interoperable positive train control (IPTC) must also meet the requirements and goals of the Rail Safety Improvement Act of 2008 and transmission band requirements mandated by the Federal Communications Commission (FCC), including, for example, those related to frequency band allocation, channel width, and spacing. Moreover, an IPTC system must also meet all of the engineering demands placed on any system being deployed in the harsh railroad operating environment.

One example of a wireless communication protocol that supports the exchange of messages to provide interoperable train control is ITCnet®, which was developed Meteorcomm, LLC of Renton, Wash. ITCnet® is capable of supporting, for example, messages for CTC, IPC, IPTC and other systems used by railways in North America. U.S. Pat. Nos. 8,340,056, 8,602,574, and 10,710,620, which are incorporated herein by reference for all purposes, disclose and describe various aspects of communication processes enabled by ITCnet®.

FIG. 1 is a high-level, schematic representation of basic functional subsystems or components of a railroad control system. In this representative example, the railroad control system 100 supports wireless communications between a central office (or network operating center) 101 and locomotives 102 and other railroad vehicles located at various points around a rail system, as well as direct communications between locomotives 102 and the electronic wayside monitoring subsystems. In communications system 100, central office 101 communicates with packet data radios on locomotives 102 through a wired telecommunications network and a series of packet radio base stations dispersed over thousands of square miles of geographical area through which the rail system operates. FIG. 1 illustrates only two, representative radio base stations 103a and 103b.

Communications system 100 also includes a series of wayside monitoring subsystems, which monitor wayside systems, such as signals, switches, and track circuits, and communicates the monitored information directly to locomotives 102 within the corresponding wireless coverage area, as well as to central office 101, through base stations 103a and 103b. FIG. 1 shows two representative wayside monitoring subsystems 104a, 104b, and 104c. As examples of typical uses of wayside monitoring subsystems 104, wayside monitoring subsystem 104a is shown monitoring a switch 105 and a signal 106, wayside monitoring subsystem 104b is shown monitoring a hand-throw switch 107. Also, for illustrative purposes, two parallel sections of track 108a and 108b, and a connecting section 109, are shown in FIG. 1, which represent only a very small part of the overall track system.

In the following discussion, a “remote radio” refers to a radio that is not at a base station. Remote radios are, for example, the radios disposed on locomotives 102 and other railroad vehicles, the radios at waysides 104a, 104b, and 104c, and other radios geographically separated from central office 101, and which are not radios at base stations 103a and 103b. Mobile remote radios refer to the remote radios disposed on locomotives 102 and other railroad vehicles, or any other remote radio that might change location.

Remote radio and base station radios can be implemented using a software defined radio (SDR). A SDR provides several possible advantages, including multi-channel capability. Thus, for example, a remote radio with multi-channel capability on the locomotive enables it to receive information from a base station and a wayside monitoring subsystem 140 simultaneously. Additionally, with a SDR, locomotives and base stations can receive status messages from multiple wayside monitoring subsystems simultaneously. This capability enables support for communications with a high density of waysides in city areas.

One challenge with interoperative train control applications, such as IPTC applications, is the need to maintain multiple communications paths between various communications nodes within the system. In addition, these multiple communications paths must support the exchange of different types of information while still meeting all of the wireless regulatory requirements imposed by the FCC.

For example, a communication path must be maintained between mobile remote radios on locomotives and a central office to support the exchange of such information as locomotive location reports, locomotive health and diagnostic data, movement authorities, files, and network management data. Another communication path must be established between the mobile remote radios on railroad non-locomotive vehicles (not shown) and the central office. The data traffic in this path includes vehicle location reports, work reports, email, and material requisitions.

Another set of communication paths are required for maintaining communications with the fixed remote radios at railroad waysides. In this case, a communication path is required between the radios at waysides and central office for supporting signal system health and status monitoring, centralized control of control points, and wayside defect detector system data and alarms. A further communication path is required between the mobile radios on locomotives and the radios at waysides, which supports wayside status updates provided to locomotives in the proximity of a given set of waysides. In a PTC system, trains generally require a status update from each approaching wayside. For each wayside within 3.5 miles ahead of a train, the age of the wayside status must not exceed 12 seconds with six 9s (i.e., 99.9999%) reliability. It is also desirable that the wayside status updates are forwarded to central office.

Finally, another communications path is required between the mobile remote radios on locomotives and non-locomotive railroad vehicles and the mobile remote radios on other locomotives and non-locomotive railroad vehicles. This path supports peer-to-peer proximity position reports so that one mobile radio is aware of the locations of nearby mobile radios.

IPTC systems use channels that are in a group of RF frequencies in the 220 MHz band, with the channel plan specified by the FCC in 47 CFR § 90.715. The FCC channel plan describes 5 kHz channels. However, where a licensee is authorized on adjacent channels, the 5 kHz channels can be aggregated over the contiguous spectrum. The bandwidth of a channel for IPTC is currently specified to be 25 kHz. It is comprised of five (5) adjacent 5 kHz channels in the FCC channel plan. This makes at least four 25 kHz channel pairs in the 220 MHz band currently available for IPTC.

IPTC systems use each 25 kHz frequency channel in a half-duplex mode, meaning that a single channel is used as communication path in both directions between two connected radios, but only in one direction at a time. In other words, each frequency channel supports both transmissions from a base station radio and transmissions from remote radios, but not simultaneously. If more than one radio transmits in the channel at the same time, then a signal collision occurs which could result in the loss of all transmissions.

Mobile radios may transmit on channels in the 221-222 MHz range or on channels in the 220-221 MHz range. Base stations are currently only permitted to transmit on channels in the 220-221 MHz range. For IPTC applications, the frequency channels in the 220 MHz band are paired into the frequency channels used by base station radios and into the frequency channels used by mobile radios. Each base station radio transmit frequency is taken from the 220-221 MHz range and paired with a mobile radio frequency from the 221-222 MHz range. According to current FCC regulations, a mobile radio may transmit or receive on either a mobile radio or base station radio frequency, while a base station radio can transmit only on a base station radio frequency. In the future, the FCC may also allow a base station radio to transmit on a mobile radio frequency, subject to certain to antenna height and power restrictions. For example, a base station radio transmitting on a mobile radio frequency may be restricted to antennas of less than 7 meters in height or to powers less that 50 Watts ERP.

In a wireless network for IPTC such as ITCnet®, the available 25 kHz frequency channels are divided into two groups: local channels and common channels. A common channel is shared by all base station radios and remote radios. A local channel is used to support the traffic from all users within a base station coverage area and is centrally controlled by that base station using a master-slave architecture. Each base station typically controls only one local channel but could control more than one. Each local frequency channel is controlled and organized by a base station.

Each remote radio can listen to multiple base stations 103, but a remote radio can select only one base station 103 to be its master; other base stations 103 are considered as neighbor base stations of the remote radio. Different local channels can be assigned to adjacent base stations 103 to prevent adjacent base stations 103 from interfering with each other, and the same local channel can be reused by multiple base stations 103 that are far apart from each other to increase spectral efficiency.

A set of 25 kHz channels in the base station frequency are set as primary local channels. Since base stations 103 can transmit with higher power in the base station radio frequency, using channels in the base station radio frequency for local channels provides larger coverage than by using channels in a mobile radio frequency. Based on the currently available 220 MHz IPTC spectrum, at least three 25 kHz channels in a base station radio frequency can be set as primary local channels. In high density areas where three primary local channels are not sufficient to support the traffic, other local channels can be used.

In ITCnet®, one 25 kHz channel is preferably reserved for a common channel. The common channel should be in a base station radio frequency that allows for both base stations 103 and remote radios to transmit in the channel. The common channel shared by every user using the CSMA scheme described above. A packet transmitted in the common CSMA channel is typically a short packet that carries very high priority data. The common channel can also be used to transmit base station beacon signals, which carry information necessary for remote radios to identify and select a base station radio, as well as to setup their receive frequencies.

### SUMMARY

Briefly, disclosed below are methods for improving performance of communications links in an asynchronous wireless network used to transmit messages for controlling movement of trains, in particular supporting positive train control systems of railroads. The methods allow for adjustment of the transmitted data rate by one radio to another radio over a wireless communication link based on one or more conditions of the link. For example, modulation and schemes with less overhead can be employed, thus increasing the throughput or data rate when an estimated link quality or conditions are relatively good while maintaining a relatively high-performance levels required of the links for reliable train control. Conversely, when the estimated link quality is relatively poor, more robust modulation and coding schemes can be used to transmit the messages that maintain the desired or necessary level of performance of the link but at the cost of reduced throughput, meaning a lower data rate. Optionally, if the estimated link quality is higher than required to achieve a predefined maximum data rate at a given default power rate, transmit power is reduced.

### BRIEF DESCRIPTION OF THE DRAWINGS

FIG. 1 is a high-level, schematic representation of basic functional subsystems or components of a railroad control system

FIG. 2A is a schematic representation of a multiple access scheme for an IPTC wireless network.

FIG. 2B is a schematic representation of a DSB cycle of the IPTC wireless network multiple access scheme depicted by FIG. 2A.

FIG. 2C is a schematic representation of a DTDMA cycle of the IPTC wireless network multiple access scheme depicted by FIG. 2A.

FIG. 3 depicts schematically a structure for a RF packet for an IPTC wireless network.

FIG. 4 is a flow diagram representing a process of estimating link quality with an estimated average signal to noise ratio generated from received signals.

FIG. 5 is a flow diagram representing a process of a remote radio determining a data rate and requesting a base station to use the data rate.

FIG. 6 is a graph representing relating error rates and signal to noise ratios at given data rates.

FIG. 7 is a flow diagram illustrating processes performed by a base station and a remote radio for adapting data rates on a channel when the remote initiates a transmission.

FIG. 8 is a flow diagram illustrating processes performed by a base station and a remote radio for adapting data rates on a channel when the base station initiates a transmission.

FIG. 9 is a flow diagram of a process for a remote radio to determine a requested transmit power.

FIG. 10 is a signal constellation diagram for DQPSK.

FIG. 11 is a signal constellation diagram for DQPSK

FIG. 12 is a constellation diagram for 16DAPSK.

FIG. 13 is a schematic representation of the basic elements of a base station radio and a remote radio that are used to provide adaptive coding and modulation and adaptive power control for the radios.

### DETAILED DESCRIPTION OF EXEMPLARY EMBODIMENTS

In the following description, like numbers refer to like elements.

The ITCnet® network is a radio network from Meteorcomm Communications, LLC that is currently utilized by Class-I railroads, short-line and commuter railroads, system integrators, and Positive Train Control (PTC) hosting providers across the United States to enable interoperable train control communication. U.S. Pat. Nos. 8,340,056, 8,602,574, and 10,710,620 describe various details of the various protocols used by the ITCnet® wireless network. Each of these patents is incorporated herein for all purposes. Briefly, the ITCnet® is an example of a suite of protocols suitable for use on networks that support IPTC. The following disclosure of adaptive coding, modulation, and power processes in a wireless network supporting IPTC systems modifies ITCnet® protocols and uses the modified ITCnet® protocols as an example for implementing the processes in an IPTC wireless network.

Previously existing ITCnet® protocols define data communication processes in an IPTC communications network or system at the application layer, network layer, link layer, and physical layer. The protocols at the link layer enable, when implemented by two nodes on the same communication link, each node to transmit data to and receive data from the other node. The link layer protocols also define processes by which the nodes are able to detect and, in some cases, detect transmission errors, as well as processes by which a node can detect a new, neighboring node or if a neighboring node is offline. The processes implement forward error correction (FEC) coding, cyclic redundancy check (CRC), and packet acknowledgement. Additionally, the link layer protocol supports over-the-air channel access based on TDMA (time division multiple access) and CSMA (carrier sense multiple access) schemes. At the physical layer, the ITCnet® protocols specify methods of sending raw bits over a physical wireless channel from one radio to another radio. For example, it defines properties for modulation, bit rate, bandwidth, frequency, synchronization, and multi-channel processing.

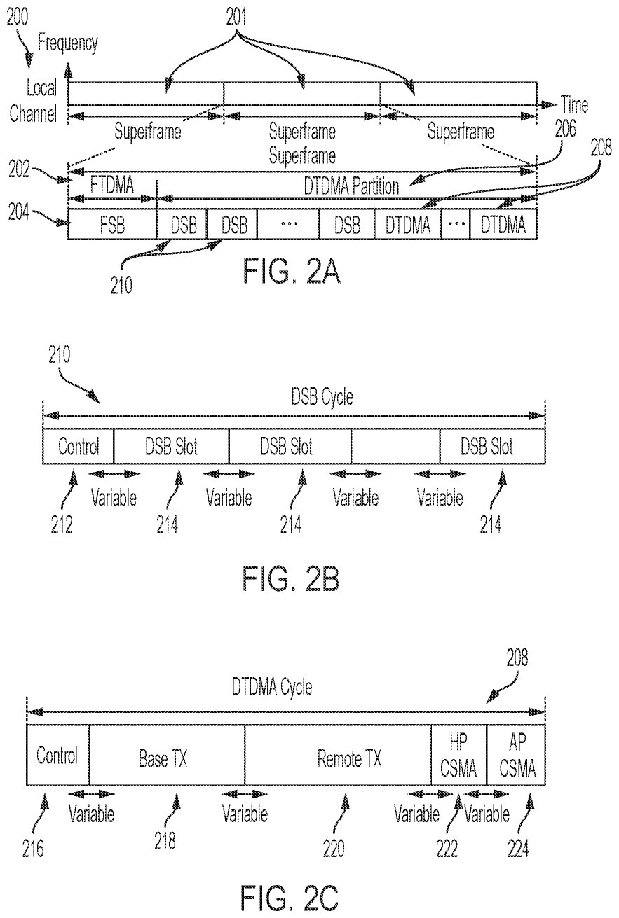

Referring now also to FIGS. 2A, 2B, and 2C, which schematically depict a multiple access scheme used by ITCnet® for communications links between neighboring radios in a wireless network. A multiple access scheme defines processes that enable base station and remote radios to cooperate to share available channel resources. The ITCnet® is a representative example of a multiple access scheme for a wireless network supporting IPTC. Like the ITCnet® protocol in general, the access schemes depicted by the figures are intended to be representative, nonlimiting examples of multiple access schemes suitable for a wireless link supporting interoperable train control messaging. The principles of the processes described below can be implemented with other multiple access schemes.

The ITCnet® scheme combines two basic types of multiple access schemes: time division multiple access (TDMA) and carrier sense multiple access (CSMA). For a particular local frequency channel 200, three different multiple-access cycles are grouped into a cyclic or periodically repeating superframe 201 of fixed duration. The superframe duration is the same for each local frequency channel, and it is set to a wayside broadcast interval. The superframes 201 are therefore synchronized across all local channels. Each superframe 201 has two partitions: a fixed time division multiple access (FTDMA) partition 202; and a dynamic time division multiple access (DTDMA) partition 206.

In the FTDMA partition 202, the local frequency channel 200 is time slotted. The FTDMA slot size can be different from one slot to another, but the allocation of the channel time to each user is fixed. The FTDMA partition can be used to transmit constant periodic traffic from remote radio users. For example, a fixed number of FTDMA slots, each having a fixed slot size, is periodically reserved for a remote radio to use at a fixed repetition rate. One FTDMA slot is, in the ITCnet® implementation, used to support one FTDMA packet. Each user can be assigned multiple FTDMA slots to transmit multiple RF packets (each of which is also referred to as a “packet” in this description). The FTDMA configuration set in advance based on channel capacity and the channel frequency required to send FTDMA data for each user in the network. For example, the FTDMA partition 202 could have one FTDMA cycle 204, which can be used to support periodic traffic such as periodic WIU (wayside interface unit) status messages. When transmitting in the FTDMA partition, a remote radio can use slot timing from a GPS pulse such that it is independent of the base station radio transmission. Each FTDMA cycle 204 in a channel would the same length, which is set based on the anticipated or expected amount of periodic traffic in at channel. However, if more than one FTDMA cycle is used in the FTDMA partition 202, FTDMA cycles can be different lengths. Furthermore, the fixed length of the FTDMA cycle on each local channel can be the same or different than the fixed lengths of FTDMA cycles on other local channels.

The DTDMA partition is, the local frequency channel 200, also time slotted, but a base station 103 controls the allocation of time slots for use by base station and remote radios (or “users”) to transmit RF packets. The partition has one or more consecutive dynamic short broadcast (DSB) cycles 210 followed by one or more consecutive DTDMA cycles 208. The DTDMA partition in a given local frequency channel can be controlled by one base station 103 or shared by multiple base stations 103. In case when the local frequency channel 200 is controlled by one base station, that base station has the control of the entire DTDMA partition. In this case, the duration of DTDMA partition at the base station is set as being equal to the duration of a superframe less the duration of the FTDMA cycle. When the local channel 200 is shared by two or more adjacent base stations, those base stations coordinate their transmissions in the DTDMA partition. The entire duration of DTDMA partition is divided among the shared base stations. For example, with N adjacent base stations sharing the local channel 200, the DTDMA partition is divided into N parts, one for each of the N base stations.

At the beginning of each DSB cycle 210, the base station in control of the local frequency channel for that DSB cycle broadcasts a DSB control packet 212. Following the control packet are one or more DSB slots 214. The slots may have variable lengths.

Each DTDMA cycle 208 is controlled by one base station 103. A DTDMA cycle 208 is used to support traffic from a base station 103 and remote radios. All traffic in a DTDMA cycle 208 is organized by the base station 103 that controls that DTDMA cycle. The length of a DTDMA cycle 208 depends on the amount of traffic, which can vary from one DTDMA cycle to the next. Thus, DTDMA can be variable length in this example. The start of DTDMA partition and the duration of DTDMA partition are configurable parameters that can be set in the base station radio. The base station radio uses GPS timing as the reference time to start and end the DTDMA partition in each superframe 201.

Each slot in a DTDMA cycle 208 is allocable for a transmission of an RF packet from a base station or a remote radio. A base station may assign a slot for a remote radio transmission to a particular remote radio or set as a contention slot. A contention slots is not assigned to a specific remote radio. Any remote radios make access the channel during a contention slot using a slotted carrier sense multiple access (CSMA) scheme.

At the beginning of each DTDMA cycle, the base station in control of the local channel broadcasts a control packet in a variable length control packet slot 216 at a default rate. The slot following the control packet is variable length base station transmission slot 218, during which the base station may, for example, transmit a unicast message intended for a particular remote radio. Following is a variable length remote radio transmission slot 220 that is assigned to a specific remote radio for transmissions. The remaining two slots, the HP CSMA slot 222 and the AP CSM slot 224, are each a variable length contention slot accessed using a CSMA scheme.

The slotted CSMA scheme is a variation of a basic contention-based access scheme where a physical channel is shared by users (i.e., base station and remote radios) with a mechanism to prevent collisions among multiple users trying to access the channel at the same time. The CSMA scheme requires that the users listen to the channel before starting to transmit to avoid possible collisions with other ongoing transmissions. Generally, when a user has a packet to transmit, the user waits for a random period of time during which the channel is sensed. If the channel is found idle, the user transmits the packet immediately. If the channel is found busy, the user reschedules the packet transmission to some other time in the future (chosen with some randomization) at which time the same operation is repeated.

In the slotted CSMA scheme a packet transmission must start at the beginning of a time slot. The slot size can be shorter than the time required to transmit a packet. When a user has packet to transmit, the user picks a random integer number and waits for that number of slots to occur before scheduling a transmission. The user then senses the channel, and if the channel is found idle, transmits its packet at the beginning of the current slot. If the channel is found busy, the user picks another random integer number and reschedules the packet transmission, as in the basic CSMA scheme. The maximum back-off time (i.e., the range of random integer numbers) is configurable. The back-off times for different data priorities can also be set to different numbers to improve the latency performance.

An assignment of a slot in each DTDMA cycle 208 may be performed by a scheduler at the base station based on transmit queue information from the base station radio and the associated (connected) remote radios. The DTDMA slot assignment is broadcast by the base station radio in the DTDMA control packet sent in control slot 216. In order for the scheduler to obtain knowledge on the remote radio transmit queues of the associated radios, each associated remote radio sends an update of its transmit queue information to the base station 103 when necessary. The remote radio can transmit its queue information in the remote radio transmission slot 220 or a contention slot. At the end of each DTDMA cycle, the scheduler uses currently available queue information of every user (i.e., base station radio or remote radio) to determine the allocation of slots in the next DTDMA cycle.

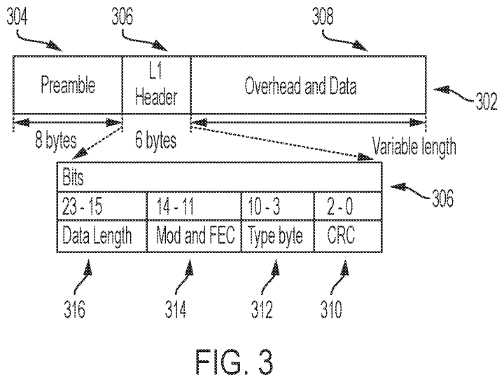

Base stations and remote radios transmit data in RF packets, which are structure blocks of binary data. Illustrated schematically by FIG. 3 is a physical-layer structure for transmissions of packets on ITCnet®. In the ITCnet® network, different types of packets can be specified. However, all ITCnet® packet types share a common structure to allow for new radios to be backward compatible with older radios. A packet 302 has two portions, one portion constituting a packet header and the other data. The packet header in this example includes fields for a preamble 304, a physical layer or “layer 1” header (“L1 header”) 306. The remaining length of the packet is its payload 308, which may include additional overhead and message data.

The preamble is used for the receiver to synchronize and detect information bits in the packet. In the embodiment used by ITCnet®, the preamble is 8 byte long. The L1 header 306 is used for packet detection and is three bytes long. The link layer overhead is used by a receiving radio, in particular its receiver, to decode and extract data from the packet. The link layer overhead may include, for example, data that indicates the packet type, addressing identifiers, a cyclic redundancy correction (CRC) code, and forward error correction (FEC) code. In the ITCnet® packet, the L1 header includes a 3-bit field for a CRC 310 used to validate the decoding of the L1 header. The CRC is followed by Type field 312 containing a value (8 bit in this example) indicating what type of packet it is. The “MOD and FEC” field 314 is a 4-bit value indicating the type of modulation and FEC being used. The Mod and FEC field value points to an entry in a look-up table that contains information about modulation and coding being used to transmits the payload 308. In this example, the table could have up to 16 possible entries, meaning that up to 16 different combinations of, for example, modulation type, FEC type, code rate and/or interleaving could be specified. The Data Length field 316, which is the number of bytes of its payload 308, exclusive of L1 header 306 and preamble 304, prior to any applied FEC. It is, in this example, an 8-bit length field. The information in the payload 308 comprises overhead and data. The information length can be varied, depending on packet type and data in the packet.

The L1 header is, in this example, always modulated and encoded using a fixed scheme. For example, the L1 header may be modulated using differential quadrature phase shift keying (DQPSK) and encoded with a convolutional code at a coding rate of 0.5. In this example, the encoded L1 header would be 6 bytes long (the input to the convolutional encoder will be 24 bits and the output will be 48 bits.)

However, as mentioned above, the information in the payload 308 is modulated and encoded using schemes indicated by the value in the MOD and FEC field 314. This allows for adaptive coding and modulation (ACM) to be used, which may be different from the modulation and coding used for the L1 header.

The processes below describe implementation in wireless networks supporting IPTC, such as ITCnet®, of ACM to increase the overall throughput, efficiency, and reliability of over at least one, and preferably each, communication or radio link between a base station and a remote radio on a local channel based on the condition of the communications link. By dynamically changing modulation and forward error correction for packets sent on the link in response to the measured conditions of the link, the processes allow in effect link margin to be converted to an increase in the data throughput. When link conditions are favorable, it is possible to use high-order modulations and forward error correction (FEC) schemes with lower overhead to increase data transfer. Conversely in poor link conditions, robust modulation and coding can be used to maintain the link, but at reduced throughput. In fading channels that model wireless propagation environments, it has been found adaptive modulation radio transmitters implementing processes described herein perform better than radio transmitters that do not adapt to exploit channel knowledge at the transmitter.

To adapt modulation and coding, the transmitter must have information about the radio link or channel. The transmitter may obtain this information on one of two ways. It may assume the channel being used for transmission is in a state similar to a similar channel on which it is receiving transmissions from other radios. It may instead, or also, receive feedback on the state of the radio link from the radio receiving its transmissions on the radio link. The feedback can be transmitted on the same or same or different local frequency channel.

In one example of an implementation of ACM on an IPTC wireless network, each remote radio receiver measures or estimates the signal-to-noise ratio (SNR) of one or more transmissions from a base station to which it is connected. A high SNR indicates good link and low SNR indicates poor link. Each remote radio measures SNR by estimating it from the signals received over a certain period of time. The remote radio then informs the base station radio to which it is connected of the condition of the link, either by sending an indication of the SNR or a recommend modulation and coding combination. Adapting the coding and modulation of transmissions over a radio link will result in a data throughput rate is predictable and provides the opportunity to increase the rate where possible.

The base station and remote radios in an IPTC wireless network may instead or in addition implement methods that allow for adaptive power control (APC) in which a radio automatically reduces transmit power from a default power level if it is not necessary for maintaining a connection between a base station and a remote radio of a certain quality. It can be reduced, for example, to a power level at or above what is necessary for achieve a desired transmission rate on a link with a desired performance level. Transmitting at a power level that is no more than necessary for achieve a given quality may reduce signal interference on the IPTC wireless network.

Dynamically adapting power levels can be used with adapting coding and modulation based on estimated link quality as represented by, for example, estimated SNR. If the estimate SNR is higher than that required to achieve the maximum transmit rate, then the transmit power is reduced to the level required to achieve the maximum transmit rate. Otherwise, the radio transmits at full power for the selected modulation.

In an example of an implementation of ACM on a wireless train control network, such as ITCnet, a local channel is controlled and organized by a base station. A remote radio connected to the base station can send a request the data rate and transmit power level to the connected base station. Base station will inform the remote radio which data rate and power to transmit.

Each remote radio estimates the quality of communication link between the remote radio and its connected base station by utilizing packets that the base station transmits in the local channel. For each packet received from the base station, the remote radio estimates the SNR value of the received signal. Then, the remote radio determines the average SNR by averaging the estimated SNR values from multiple received packets.

For example, in the ITCnet protocol described above, there are several broadcast packets from the base station sent at a default rate that can be used by remote radio to estimate the link quality. These packets include, for example, any one or combination of two or more of the following: the control packet from the base station radio transmitted in DSB control slot 210, the control packet transmitted by the base station packet in the DTDMA control slot 216, and base station beacon broadcasts that are sent periodically at a configured or predetermined fixed interval. In addition to broadcast packets, a remote radio may, optionally, use unicast packets that a base station direction directly to the remote radio to estimate the quality of the communication link. The unicast packets are sent in the base station transmission slot 218 of the DTDMA cycle.

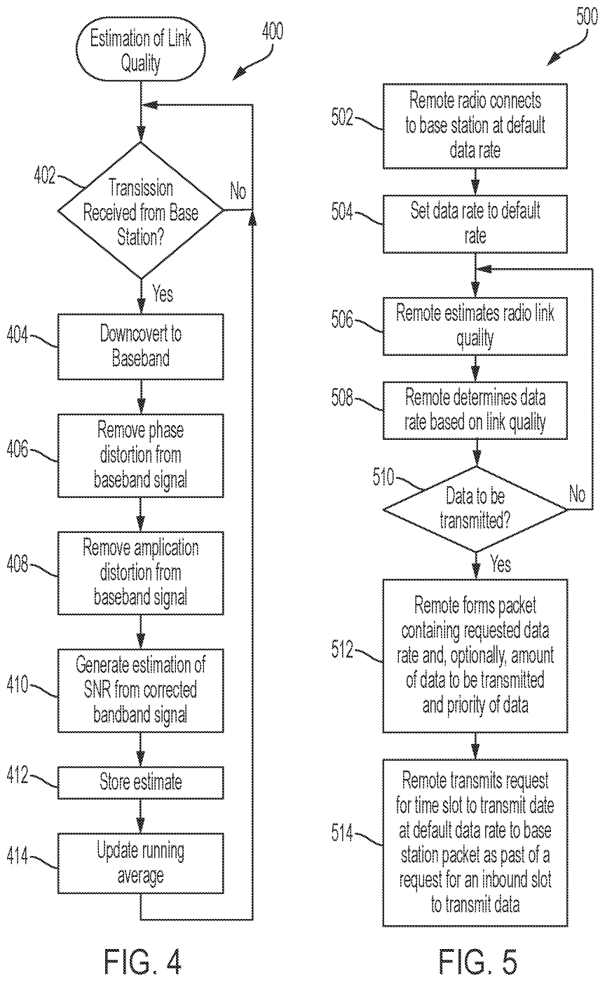

FIGS. 4 to 8 illustrate non-limiting, representative examples of embodiments of processes for radios within an IPTC wireless network that adapt coding and modulation and adapt power transmit levels based on estimated link quality.

The flow diagram of FIG. 4 illustrates the basic steps of a link quality estimation process 400 of a remote radio. The process can be implemented, for example, by hardware circuits, programmed on special-purpose digital signal processors, or software running on general purpose microprocessors, or a combination of them, used for implementing the radio. The process 400 is intended to produce a value that reflects an average signal-to-noise (SNR) ratio, which is the noise level relative to the average received signal level regardless of the channel conditions. As indicated by decision block 402, the process is performed for each packet received from a base station to which the remote radio is connected during a given period, which can be configurable. The packets can be one of the broadcast packets, any or more or all the broadcast packets, the unicast packets, or all packets of any type transmitted by the base station and received by the remote radio. The signal received by the remote radio is at step 404 processed through an RF chain, with the processed signal downconverted to a baseband signal. Although optional, it is preferred that amplitude and phase distortion caused by fading channels is removed at steps 406 and 408 so that they have no effect on the estimated SNR value. The radio then generates at step 410 a value that is an estimate of the SNR of the received signal using, for example, a mean square error estimation process. The estimate of the SNR is stored at step 412.

To obtain SNR average, the radio performs a process at step 414 for generating an average of the estimated SNR values over the given period. In one embodiment, the SNR average is a weighted moving average of the estimated SNR values obtained by multiplying weights to the SNR values estimated from multiple packets received packets over a predetermined period that is a moving window of a predetermined length. The length of window is configurable. The default window length can be, for example, set at 8 seconds which is equivalent to 2 ITCnet superframes. If the window length is T seconds, the average SNR can be generated according to the following equation:

$$S N {R}_{AVG} = {\sum }_{i = 1}^{{N}_{T}} {w}_{i} S N {R}_{l} \qquad Equation ( 1 )$$

Where N_{T} is the number of base station packets received within T seconds before the averaging time, SNRᵢ is the estimated SNR of the i^{th} received packet, and wᵢ is the weight for i^{th} received packet. The set of weights wᵢ is configurable. Examples of default weights are wᵢ=I/N_{T} for all i. N_{T} can be different for each window, depending on the number of packets from the base station received in that window.

Referring now to FIG. 5, a flow diagram representing the basic steps of a process 500 of a remote radio during which it connects to a base station, estimates link quality, determines the appropriate data rate for the link to meet the packet success rate requirements, and sends a request for transmission data using the determined data rate.

At step 502 the remote radio connects to a base station on a local channel. When a remote radio wants to connect to a base station, it initiates the connection process by sending packet, referred to herein as an “acquire” packet, to the base station using the network's default data rate. The default data rate can be, for example, is set to a rate that will meet the required performance metrics under most if not all conditions. An example of a default data rate for a remote radio on a locomotive radio is 24 kbps in versions of ITCnet in use at the time of application. Thus, communication between base station and remote radio on a communication link starts with inbound messages from remote radio.

The remote sets at step 504 the data rate for the link equal to predetermined default rate for the wireless network. An indication of the data rate is stored by the remote radio in memory.

At step 506, the remote begins a process of estimating quality of the link. The process 400 of FIG. 4 is an example of this process. The process will continue. Any changes in the channel condition are stored.

Based on the estimated or measured link quality, the process determines a data rate for the link at step 508. If the radio determines that the data rate should be set at a rate other than the currently stored data rate, the memory is updated with the determined data rate, and this becomes the data rate that the remote radio will request the base station to use for transmission over the link. The determination or updating of the stored data rate based on estimated link quality may take place on periodic basis, in response to a timer triggering, in response to a change in the stored value of the channel condition or quality metric(s)—e.g., the SNR—determined by the radio in step 504, in response to receiving data for transmission (or other signal for the need to transmit data), or a combination of any two or more of these events. These are non-limiting examples.

In this example, the average of estimated SNR generated using, for example, process 400 (FIG. 4) is used to select a maximum data rate that can be achieved while still meeting performance requirements for the link. In one example implementation, the determination is made using a look up table associating data rate values with an average SNR. The data rate values are, in this example, maximum data rate values determined based on modelling the takes into account performance requirements for the link and, in this embodiment, other possible real-world conditions. The data rate values for a given estimated average SNR value in the look table may also be set (and, optionally, updated dynamically) using, in whole or in part, field measurements.

One metric for performance of a communication link between a base station and a remote radio on given local channel to support train control is packet error rate. Because communication must be very reliable for train control, particularly PCT, the percentage of successful transmission of a packet to support train control should be relatively high, such as 90% or greater. At 90%, the packet error rate would be 10%. Furthermore, a wireless network supporting PCT must support moving trains, which in some cases are capable of speeds of up to 160 mph. Channel fading is possible. Therefore, in addition to the performance requirements for positive train control, this example takes into account channel fading due to movement of strain the setting of a maximum data rate for a given SNR value when using modelling.

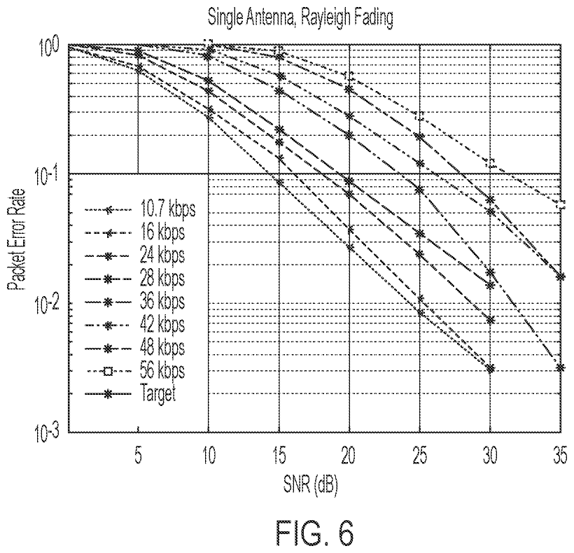

Referring briefly to FIG. 6, this graph plots the result of a modelling of packet error rates as a function of SNR at different data rates. Each of the curves represent predicted packet error rates (y-axis) as a function of SNR (z-axis) at a given data rate. With this information, the estimated link quality metric—the average SNR in this example—can be associated a predetermined maximum data rate for the SNR when using a given modulation scheme and coding rate.

Shown below is an example of a table (Table 1) associating data rates achievable using the stated modulation parameters and coding rates with the SNR required to maintain a packet success rate of 90% at those data rates. The required SNR also include a margin to accounts for implementation loss and estimation errors that could happen in actual operation.

TABLE 1

| SNR (dB) | Modulation | Coding Rate | Data Rate (kbps) |
|---|---|---|---|
| 15 | DQPSK | 1/3 | 10.7 |
| 17 | DQPSK | 1/2 | 16 |
| 19 | DQPSK | 3/4 | 24 |
| 20 | DQPSK | 7/8 | 28 |
| 24 | D8PSK | 3/4 | 36 |
| 27 | D8PSK | 7/8 | 42 |
| 30 | 16DAPSK | 3/4 | 48 |
| 33 | 16DAPSK | 7/8 | 56 |
| 44 | 64DAPSK | 3/4 | 72 |
| 46 | 64DAPSK | 7/8 | 84 |

The table 1 is a representative, non-limiting example of adaptive modulation and coding scheme to increase or decrease data rates. With each modulation scheme, two or more coding rates are used, with the higher coding rate achieve higher data rates using the same modulation scheme. However, alternatively, a single data rate could be used for a given modulation scheme, or certain of the modulation schemes may have only one coding rate. Each of modulation formats or schemes in this example relies on modulating the phase of a carrier signal using phase-shift keying (PSK), with the symbols being encoded differentially. Such schemes generally being referred to as differential phase-shift keying (DPSK) and allow for non-coherent data transmission. At the lower data rates, the more reliable forms of DPSK are used. At the lower data rates, the DPSK modulation scheme use 4 phases (known as differential quadrature phase shift keying or DQPSK) and 8 phases (D8PSK). At the highest data rates, the amplitude of the carrier signal is also modulated using a modulation scheme known as differential amplitude phase-shift keying (DAPSK). In this example, 16DASPSK and 64DAPSK formats are used to achieve the highest data rates. In alternative embodiments, different modulation schemes can be substituted. Software defined radios are used to implement transmitters and receivers capable modulating and demodulating packets sent using different modulation and coding schemes.

Referring back to FIG. 5, when the remote radio wants to transmit data, as indicated by decision step 510, the remote radio sends or transmits at step 512 a request to the base station using a packet that contains a requested data rate. The requested data rate is set equal to the stored data rate determined at step 508. The packet may, optionally, also contain an indication of the amount of data that needs to be transmitted and/or a priority. At step 514, the remote transmits the request to the base station at the default rate for the wireless network, not the requested data rate.

In an ITCnet wireless network, for example, the remote radio sends a request for inbound slot in which to transmit in the form of a QSTAT packet that is sent in the CSMA slots 222 or 224 of a DTDMA cycle 208 (see FIGS. 2A-2C). The QSTAT packet includes information indicating one or more of the following: the requested data rate determined at step 508; the amount of inbound data to transmit; the priority of data.

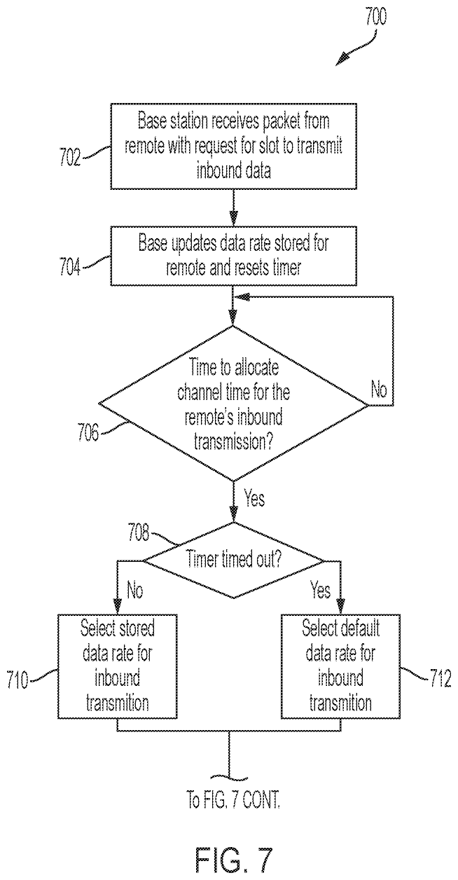

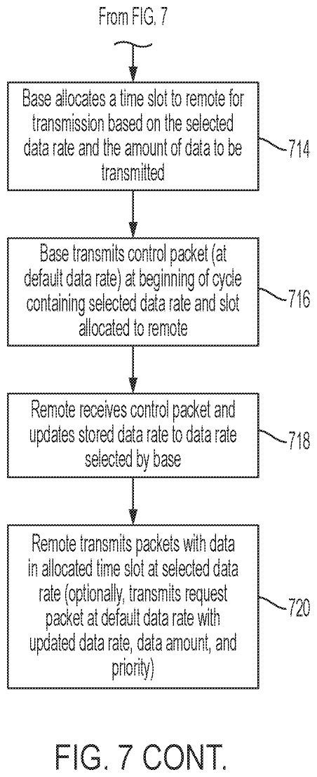

FIG. 7 is a flow diagram for a process 700 performed by the base station and remote radio after the remote radio sends a request for an inbound transmission slot, such as at step 514 of the process 500 (FIG. 5). After the base station receives the packet, such as a QSTAT packet, at step 702 from the remote radio, the base station base station records the remote radio's requested data rate and resets a timer for that requested data rate at step 704. If the base station receives any requested data rate information from the remote radio before the base station allocates time slot to the remote radio, the base station updates the remote radio's requested data rate and resets the timer.

At step 706, when it is time for the base station to allocate channel time for the remote radio's inbound transmission, the base station selects the data rate for the remote radio to transmit and allocate the time slot based on the selected data rate and the amount of data that the remote radio requested. As indicated by steps 708, 710 and 712 the base station selects the remote radio's requested data rate if the timer for the requested data rate has not expired. Otherwise, the base station selects the default data rate for the network. The base allocates a time slot, as indicated by step 714, and transmits at step 716 a control packet to the remote radio that contains information on the assigned slot for transmission and the selected data rate. In one embodiment, the packet is transmitted at the default data rate for the network. For ITCnet, the base station control packet is broadcast at the beginning of the DTDMA cycle 208. Base station DTDMA control packets are, in one embodiment, always transmitted at the default rate.

After the remote radio receives the base station control packet at step 718, the remote radio may transmit at step 720 the data or payload portions of packets using the predetermined modulation and coding scheme and parameters defined for the selected data rate for the channel specified by the base station in the control packet. However, the remote radio may instead transmit other types of packets, including for example a control packet (such as an ITCnet QSTAT packet) in the allocated time slot to provide to the base station updated information, such as a change to the requested data rate, the amount of data for transmission, and/or the priority of the data. The control packet is transmitted at the default data rate, using the predetermined modulation and coding scheme defined for the default rate.

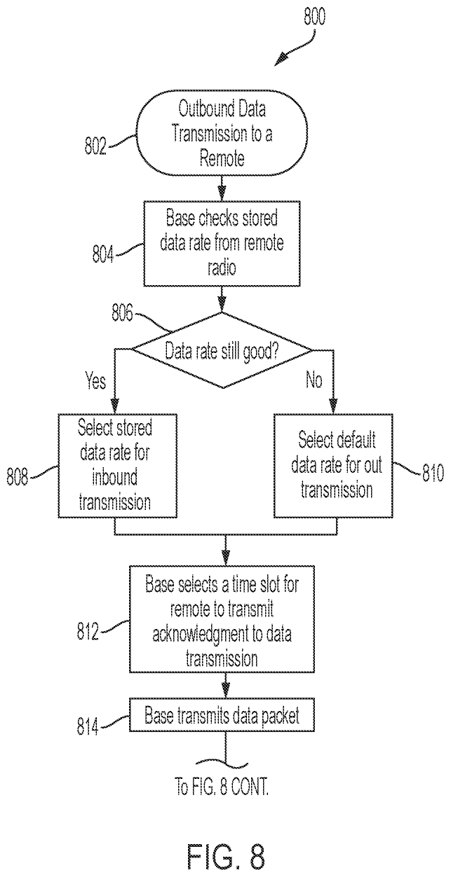

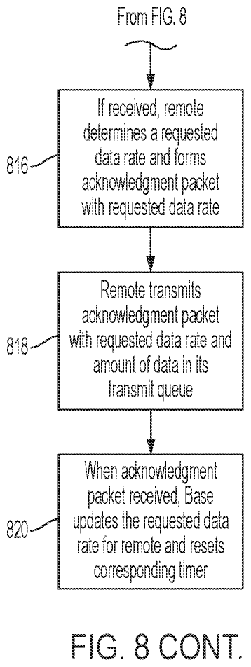

Referring now to FIG. 8, if a communication between a base station and a connected remote radio starts with an outbound message from the base station, at step 802, the depicted flow diagram describes a representative process 800 between the base station and remote radio for adapting the transmission data rate based on link conditions. As indicated by steps 804, 806, 808 and 810, the base station selects a data rate for outbound transmission to the remote radio by checking the stored data rate for the remote radio, which should be the last received requested data rate from the remote radio. If the timer that was started when the requested data rate is not expired, the base station selects the stored data rate as the rate for outbound transmission to the remote radio. If the time is expired, then the base station selects the default data rate. The base station also allocates a time slot after the outbound slot in which it transmits the message at step 814 for the remote radio to acknowledge the reception of the outbound packet.

Upon receiving the outbound packet from the base station at step 816, the remote radio determines an updated requested data rate for communication with the base station using a link quality estimation and data rate that it determines with, for example, processes 400 (FIG. 4) and 500 (FIG. 500). At step 818, the remote radio transmits in the allocated acknowledgment slot an acknowledgment packet to the base station. The acknowledgment packet may also include one or more of the following types of information: the amount of data in the remote radio transmit queue; and the remote radio's updated requested data rate. When the base station receives the acknowledgment packet at step 820, the base station stores the remote radio's requested data rate and resets the timer for the stored data rate.

As previously mentioned, in the ITCnet protocol, the local channel is organized by base station. The radios associated with that base station transmit in the assigned slots do not interfere each other. However, with base station frequency reuse, the radios associated with different base stations that use the same frequency channel can transmit at the same time and interfere each other. By using lower transmit power if channel conditions permit, the base station and remote radios have the option of reducing reduce transmit power to reduce interference from other radios simultaneously transmitting in the same frequency channel. When done only when the highest permitted data rate can still be maintained, the power may be reduced without reducing channel throughput.

In one embodiment, transmit power is reduced from a default transmit power rate only when the base station or remote radio is transmitting at a highest permitted data rate. At lower data rates, the base station and remote radios transmit at full power and use an ACM process such as those described above to adjust the transmit data rate on a link based on link quality, as described above in connection with FIGS. 4 to 8. When the quality of a link between a base station and a remote radio is good enough to allow transmissions on the link at the highest permitted data rate with lower transmit power while still meeting the link performance requirement, the radios on the link may reduce its transmit power to lower than the default power.

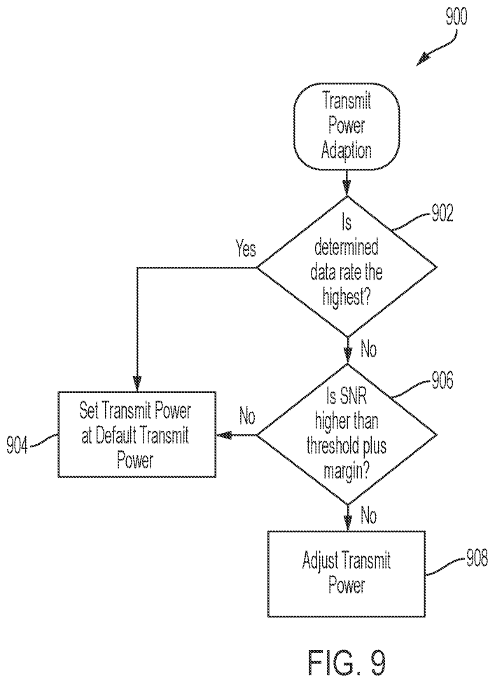

FIG. 9 is a flow chart depicting an example of processes 900 for adapting transmit power in a remote radio in connection with the processes described above in connection with FIG. 5. As indicated by steps 902 and 904 of FIG. 9, if the estimated the determined data rate at step 508 (FIG. 5) is less than highest data rate, the transmit power for the remote radio is set to the default transmit power at step 904. If, as indicated by step 906, the SNR is not more than a SNR threshold, which can be the SNR used for selecting the highest data rate, plus a margin, the transmit power is set also set to the default transmit at step 904. An example of a margin that can be used is 3 dB. Otherwise, an adjustment to the transmit power is stored by the remote at step 908 based on the estimated SNR less the SNR threshold less the margin. Thus, at step 508 both a data rate and a transmit power are set and stored by the remote radio.

In the processes described above, when the remote radio transmits to the base station a packet containing a requested data rate, it also includes a requested transmit power. However, alternatively, it may omit the requested transmit power from the packet if the requested data rate is not the highest data rate, in which case it can be assumed by the base station that it requested transmit power is the default transmit power.

Thus, for example, when the remote radio sends a request for inbound slot to the base station using default data rate and default transmit power, which is step 514 of FIG. 5, the request also includes a requested transmit power in addition to a requested data rate and, optionally, other information such as the priority and amount of the data to be transmitted to the base station. This information, in an exemplary embodiment of ITCnet, is formed into a QSTAT packet that is sent in the CSMA slots of the DTDMA cycle as discussed above. Thus, the QSTAT packet includes the following information: amount of inbound data to transmit; the priority of data; the requested data rate; the requested transmit power.

In the process 700 of FIG. 7, after base station receives the packet from the remote radio requesting an inbound slot at step 702, base station records in addition to the requested data rate the remote radio's requested transmit power and resets the timer for the stored data rate and transmit power at step 704. As previously descried in connection with FIG. 7, if the base station receives any requested data rate and transmit power information from the remote radio before the base station allocates time slot to the remote radio, the base station updates the remote radio's requested data rate and transmit power and resets the timer.

When the base station transmits a control packet at step 716, the base station includes also selected transmit power with the selected data rate. Thus, if the timer is not expired, the base station selects the stored data rate and transmit power that the remote radio last sent and includes it in the control packet. Otherwise, the base station selects the default data rate and default transmit power for the inbound transmission and includes it in the control packet. The control packet is, in addition to always being transmitted the default data rate, is transmitted at the default transmit power. At step 720, the remote radio transmits in the allocated slot using the selected data rate and transmit power indicated in the control packet. If the remote radio choses to send a packet, for example an ITCnet QSTAT packet, in the allocated time slot to provide the base station updated information, it includes the requested transmit power in addition to the requested data rate.

In the process 800 of FIG. 8, when the base station selects at step 806 a data rate it also selects a transmit power for the outbound transmission to the remote radio by checking stored requested data rate and transmit power from the remote radio. If the timer for the requested data rate is not expired, the base station selects the stored requested data rate and transmit power for outbound transmission to the remote radio steps 812 and 814. If the time is expired, then the base station selects instead the default data rate and power. Upon receiving the outbound packet from the base station at step 816, the remote radio uses base station's selected data rate and transmit power for communication with the base station. In the allocated acknowledgement slot, the remote radio sends an acknowledgement packet to the base station. The acknowledgement packet may include, in addition to the amount of data in the remote radio transmit queue and remote radio's requested data rate, the remote radio's requested transmit power. When the base station receives the acknowledgement packet, the base station updates and stores the remote radio's requested data rate and resets the timer, as indicated by step 820, and also updates and stores the remote radio's requested transmit power.

For direct peer-to-peer communications between two remote radios, the remotes radios may form a link over one or more predesignated common local channels and use a contention access scheme, such as CSMA, to access the channel. In ITCnet protocol, the direct peer-to-peer communications is supported in common channels (also known as DirectRF channels). The common channels are unorganized and shared by any ITC radios in the network. Each remote radio listens to the common channels. A remote radio (the transmitting remote radio) may transmit to another remote radio on one of the common local channels when the transmitting remote radio finds that the channel is idle. If the remote radio to which the packet is sent (the receiving remote radio) successfully receives the transmitted packet, the remote radio responds with an acknowledgement packet. The remote radio can also send another packet with data immediately after sending the acknowledgement packet.

The concepts of adaptive coding and modulation and adaptive power control processes described connection with FIG. 4, steps 502 to 510 of FIG. 5, and FIG. 9 can be applied in direct peer-to-peer communications between two remote radios. Such processes can be effective when the two remote radios have multiple packets to transmit to each other and the communication is not intermittent. The remote radios always start transmitting at the default data rate and power. After the peer-to-peer communications continue for a period of time, the radios are able to estimate the link quality based on the received signals and select transmit rates and/or power levels based on the estimated link quality. If the communication is intermittent or packets are lost, the radios restart the process. To determine the appropriate data rate and transmit power, each of the remote radios may apply the process 400 using signals received from the peer remote radio. The time period for link quality estimation can be configurable.

ITCnet in general, and in particular the multiple-access schemes and packet structures represented by FIGS. 2A-2C and FIG. 3, are intended to be a non-limiting, representative examples of multiple-access schemes and packet structures that can be used with the processes described herein. Although they may be used to advantage with wireless networks based on ITCnet® protocols based according to the processes described above, the processes be adapted for implementation in other types of wireless networks supporting train control. They not limited to use with ITCnet® protocols except to the extent expressly indicated.

Described below are additional details and examples of adaptive coding and modulation (ACM) and adaptive power control (APC) methods that adaptively adjust a transmission scheme (TS) used on a channel link based on the channel link quality for wireless networks used to support railroad and similar transportation systems, and in particular wireless networks that support train control. The methods are described in reference to those that use relevant ITCnet protocols or substantially similar ones. Aspects of the methods may find use in other types of wireless networks that support real time applications.

The TS when using ACM and APC in the examples below are the combination of the modulation, forward error correction (FEC) coding scheme, and transmit power for the channel link. However, if only ACM is used, the TS is the combination modulation and FEC scheme being used for the channel link. If only APC is being used, it is the transmit power. The possible modifications, alternatives, and examples are given in context of a wireless network implementing the ITCnet protocol, but could be used in networks with similar protocols, including future versions of the ITCnet protocol.

For ITCnet or another ITCnet-like wireless network, ACM and APC are applied to unicast traffic. This does not, however, foreclose the possibility of ITCnet or other wireless network applying ACM, APC, or both or described herein or in other ways to other types of traffic. Unicast traffic can be sent between a base station and a remote in a local channel or between remote and remote in the DirectRF channel. The following description primarily focuses on ACM and APC for the unicast communications between base and remotes in local channel. However, each may be used in a DirectRF channel.

ACM and/or APC may be applied only to select packets used by the wireless system. The following Table 2 is one example of the application of ACM and APC to packets in ITCnet. The table lists the packet types on the left side and whether ACM and APC are applied.

TABLE 2

| Packet Name | ACM/APC Applied |
|---|---|
| Base Beacon | No |
| QSTAT | (optional) |
| ACK | No |
| ACQ | No |
| TOD | No |
| CNTL | No |
| DSB CNTL | No |
| DSB SBM | No |
| FSB SBM | No |
| LBM | No |
| UNICAST | Yes |

Applying ACM/APC only to unicast messages (UCM) only to ensure that there is no negative impact on Positive Train Control (PTC) operation when employing the ACM/APC scheme in ITCnet. However, for further optimization, the ACM/APC can be applied to other packets such as CNTL and ACK.

ACM and/or APC can also be applied to a QSTAT (a remote transmit queue status message) packet transmitted in the R-TX section of DTDMA cycle. If the ACM/APC is not applied to QSTAT and a base station is scheduling for a high rate UCM, a QSTAT message (not at high rate) may not fit in the required slots. The slots will need to be always big enough for QSTAT messages or QSTAT messages must be allowed to adapt. It is preferred that ACM/APC not be applied to QSTAT messages transmitted in CSMA section of DTDMA cycle. If all connected remotes have a SNR which allows it, a CTL packet could apply ACM/APC to the level of the worst SNR of the connected remotes, unless HP or AP CSMA is being allocated.

For communications in the interoperable 220 MHz band using ITCnet protocol, the modulations and coding schemes for ACM identified in Table 3 below have been found to be effective. Table 3 shows the modulations and coding for ACM and the percentage change from the default rate used in radios currently used for ITCnet. The default rate for ACM refers to full rate, which is 24 kbps, using DQPSK modulation with FEC coding rate of ¾ (convolutional code). The FEC scheme for other rates in the table is convolutional coding. The lowest data rate for ACM specified below is the same as what used in the current PTC operation given that one use of the ACM/APC is to increase the channel capacity. The ACM and APC methods described herein could be applied to lower data rate ranges to increase signal coverage. Table 3 includes only three modulations, namely DQPSK, D8PSK, and 16DAPSK for baseline purpose. Higher modulations such as 64DAPSK and QAM could also be employed to further increase the channel capacity.

TABLE 3

| | Coding Rate | Data Rate | |
|---|---|---|---|
| Modulation | (Convolutional) | (kbps) | % Change |
| DQPSK | 3/4 | 24.0 | 0.0 |
| DQPSK | 7/8 | 28.0 | 17% |
| D8PSK | 3/4 | 36.0 | 50% |
| D8PSK | 7/8 | 42.0 | 75% |
| 16DAPSK | 3/4 | 48.0 | 100% |
| 16DAPSK | 7/8 | 56.0 | 133% |

The DQPSK modulation refers to pi/4 Differential Quaternary Phase Shift Keying modulation. For DQPSK, the encoded bit sequence is paired into sets of two-bit binary data cₖ⁽⁰⁾ and cₖ⁽¹⁾ where k is the symbol index. These bits are mapped to the k^{th} complex-valued symbol sₖ: sₖ=e^{jΔØ}^{ₖ}, where Δϕₖ is the phase transition factor. The phase transition factor is calculated by applying Gray coding to the two binary bits cₖ⁽⁰⁾ and cₖ⁽¹⁾, according to the DQPSK modulation in Table 4.

TABLE 4

| cₖ⁽¹⁾ | cₖ⁽⁰⁾ | ΔØₖ |
|---|---|---|
| 0 | 0 | π/4 |
| 0 | 1 | 3π/4 |
| 1 | 1 | −3π/4 |
| 1 | 0 | −π/4 |

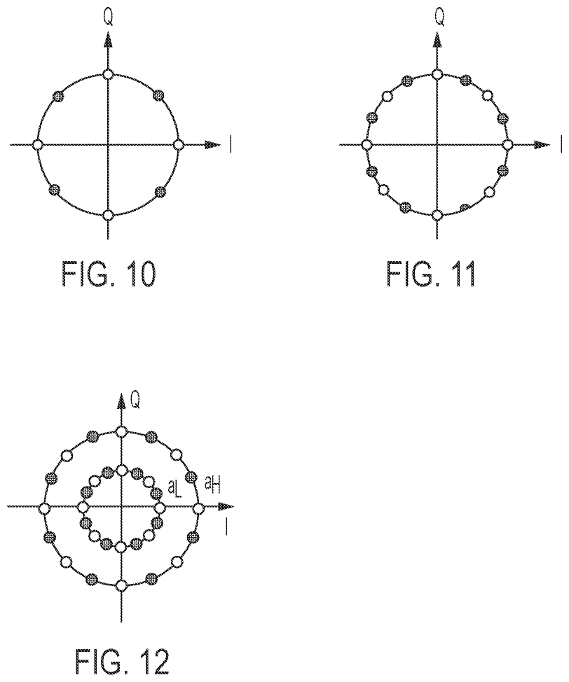

The modulation symbol dₖ is formed by applying a phase offset to previous symbol dₖ₋₁ and is defined as dₖ=sₖdₖ₋₁=dₖ₋₁e^{jΔØ}^{ₖ}, where d₀=1. Alternatively, the phase transitions can be represented as Øₖ=Øₖ₋₁+ΔØₖ. The corresponding signal constellation diagram for DQPSK is shown in FIG. 10.

The D8PSK modulation refers to pi/8 Differential 8 Phase Shift Keying modulation. The encoded bit sequence is grouped into sets of three-bit binary data cₖ⁽⁰⁾, cₖ⁽¹⁾, and cₖ⁽²⁾ where k is the symbol index. Similar to DQPSK modulation, these bits are mapped to the k^{th} complex-valued symbol sₖ: sₖ=e^{jΔØ}^{ₖ}, where Δϕₖ is the phase transition factor. The phase transition factor is calculated by applying Gray coding to the three binary bits cₖ⁽⁰⁾, cₖ⁽¹⁾, and cₖ⁽²⁾, according to the D8PSK modulation in Table 5.

TABLE 5

| cₖ⁽²⁾ | cₖ⁽¹⁾ | cₖ⁽⁰⁾ | Δϕₖ |
|---|---|---|---|
| 0 | 0 | 0 | π/8 |
| 0 | 0 | 1 | 3π/8 |
| 0 | 1 | 1 | 5π/8 |
| 0 | 1 | 0 | 7π/8 |
| 1 | 1 | 0 | −7π/8 |
| 1 | 1 | 1 | −5π/8 |
| 1 | 0 | 1 | −3π/8 |
| 1 | 0 | 0 | −π/8 |

The modulation symbol dₖ is formed by applying a phase offset to previous symbol dₖ₋₁ and is defined as dₖ=sₖdₖ₋₁=dₖ₋₁e^{jΔØ}^{ₖ}, d₀=1. Alternatively, the phase transitions can be represented as Øₖ=Øₖ₋₁+ΔØₖ. The corresponding signal constellation diagram for D8PSK is shown in FIG. 11.

The 16DAPSK (Differential Amplitude and Phase Shift Keying modulation) is a modulation scheme that combines 8-DPSK (pi/8 Differential 8 Phase Shift Keying) and 2-D8PSK (Differential Amplitude Shift Keying). The constellation diagram for 16DAPSK is shown in FIG. 12.

The constellation is comprised of two rings, each containing 2 sets of 8 constellation points, each corresponding to alternating pi/8 phase shift between consecutive symbols. A ring factor α is defined as:

$$α = \frac{{a}_{H}}{{a}_{L}}$$

where a_{L} and a_{H} (a_{L}<aH) are the amplitude levels for the inner and outer rings, respectively. Analysis shows that the optimal value for α is 2. The encoded bits are grouped into sets of four-bit binary data cₖ⁽⁰⁾, cₖ⁽¹⁾, cₖ⁽²⁾, and cₖ⁽³⁾, where k is the symbol index. These bits are mapped to the k^{th} complex-valued symbol sₖ:

sₖ=rₖe^{jΔϕ}^{ₖ}

where rₖ is the amplitude transition factor, and Δϕₖ, is the phase transition factor. The phase transition factor is calculated by applying Gray coding to the three binary bits cₖ⁽⁰⁾, cₖ⁽¹⁾, and cₖ⁽²⁾, according to the 16DAPSK phase transitions in Table 6.

TABLE 6

| cₖ⁽²⁾ | cₖ⁽¹⁾ | cₖ⁽⁰⁾ | Δϕₖ |
|---|---|---|---|
| 0 | 0 | 0 | π/8 |
| 0 | 0 | 1 | 3π/8 |
| 0 | 1 | 1 | 5π/8 |
| 0 | 1 | 0 | 7π/8 |
| 1 | 1 | 0 | 9π/8 |
| 1 | 1 | 1 | 11π/8 |
| 1 | 0 | 1 | 13π/8 |
| 1 | 0 | 0 | 15π/8 |

The remaining binary bit cₖ⁽³⁾ determines which one of the two possible 8-DPSK rings is used, the inner ring with amplitude a_{L} or the outer ring with amplitude a_{H}. The amplitude of the current symbol aₖ is found by multiplying the amplitude of the previous symbol aₖ₋₁ by the amplitude transition factor rₖ, as defined in Table 7. The transmitted symbol dₖ is therefore equal to:

dₖ=aₖe^{jϕ}^{ₖ}=sₖdₖ₋₁=rₖe^{jΔϕ}^{ₖ}*aₖ₋₁e^{jΔϕ}^{ₖ₋₁}=rₖaₖ₋₁e^{j(Δϕ}^{ₖ}^{+ϕ}^{ₖ₋₁}⁾

where dₖ₋₁ is the previously transmitted symbol.

TABLE 7

rₖ

| cₖ⁽³⁾ | aₖ₋₁ = a_{L} | aₖ₋₁ = a_{H} |
|---|---|---|
| 0 | 1 | 0 |
| 1 | α | 1/α |

Table 8 is one example of list of transmission schemes for the methods of ACM and APC described above suitable for ITCnet or a protocol that is, in relevant part, substantively similar.

TABLE 8

| Transmission | Data Rate | | | Coding |
|---|---|---|---|---|
| Scheme (TS) | (kbps) | Tx Power | Modulation | Rate |
| 1 | 24.0 | Pmax | DQPSK | 3/4 |
| 2 | 28.0 | Pmax | DQPSK | 7/8 |
| 3 | 36.0 | Pmax | D8PSK | 3/4 |
| 4 | 42.0 | Pmax | D8PSK | 7/8 |
| 5 | 48.0 | Pmax | 16DAPSK | 3/4 |
| 6 | 56.0 | Pmax | 16DAPSK | 7/8 |
| 7 | 56.0 | Pmax − ΔP | 16DAPSK | 7/8 |
| 8 | 56.0 | Pmax − 2ΔP | 16DAPSK | 7/8 |

There can be additional modulations and transmission schemes that are used, including ones that have higher or lower values or both higher and lower values. Pmax is a maximum power that a radio is allowed to transmit. A base station should inform the remotes the maximum power that they can transmit. This can be done by including Pmax in a base beacon transmission and letting the remote transmit within the Pmax level. The ΔP is a power adjustment step in decibels (dB). The ΔP should be configurable and adjusted based on testing. Power is controlled only in transmission schemes 7 and 8. If APC is not used or is disabled, the list of available transmission schemes would be limited to include the first six transmission schemes.

In this example, each radio (base station and remote) is programmed or configured with a set of transmission schemes that it can support. The base station and remote exchange and agree on the set of allowed transmissions schemes when the remote initiates connection to the base station. This set of transmission schemes could be, for example, sent on an L3 message. Further details of the exchange of messages between the base station and the remote are provided below. For communications between two remotes in a DirectRF channel, the remotes should also exchange the set of TSs when they first communicate to each other.

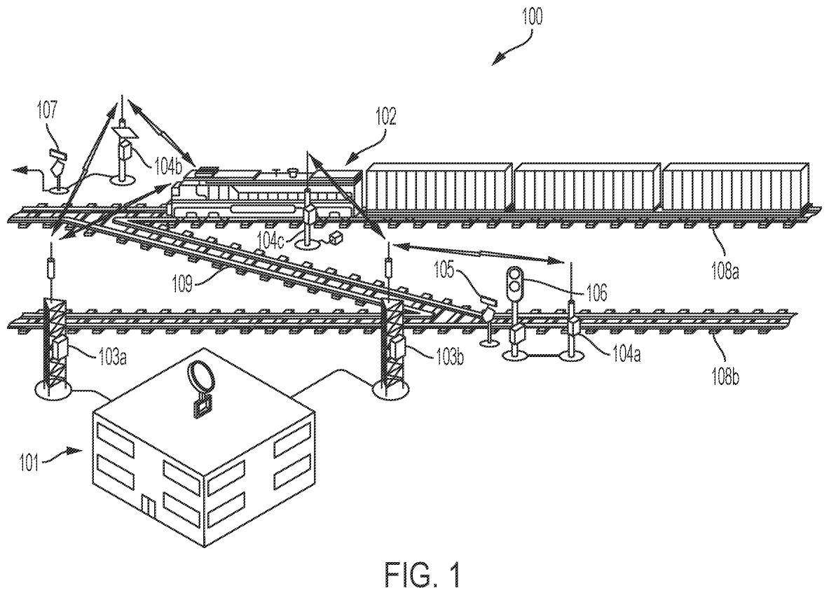

In a transmission link established between two radios, each radio also sends an indication of the transmission scheme to the other radio (a “link partner”) during communications. The transmission scheme indication provides information about the transmission scheme for the communication link. Specifically, when a radio receives an addressed packet from the link partner, the radio estimates the quality of the communication link. The radio may send the link quality estimation to the link partner or use the link quality estimation to determine the transmission scheme and send an indication (a TS indication) to the link partner. Non-limiting and representative examples of the transmission scheme indications that could be used to send to a link partner include any one or more of the following: an estimated SNR value, which can be the actual value or a code that represents the estimated SNR or that the SNR is within one of two or more predefined ranges; an estimated link quality; an achievable transmission scheme value; an indication (a value) representative of a step up or down from a current transmission scheme; an indication (for example, a binary value) that indicates that the current transmission scheme is less than an achievable transmission scheme; and an indication (a value) representing an action to be taken, for no change, up, down, go to a default transmission scheme. Any one or more of these TS indications can be used in the methods described in connection with FIGS. 1 to 9.

Each of the examples of TS indications have advantages and disadvantages. The last three examples may require that radio have the current transmission scheme used by the link partner, and therefore may be less desirable in situations in which the radio might not have correct knowledge of the transmission scheme currently used by the radio of the link partner. Although not required, requiring only the estimated SNR to be sent may limit optimization of the transmission scheme using other parameters for link quality estimation. Requiring use a TS indication other than SNR (or a value indicative of SNR) or allowing for multiple TS indications may allow for better optimization of the transmission scheme for the link. If using a link quality estimate is sent, it will need to be defined, which may require having to update or accommodate previously deployed radios if the definition need to change.

The described methods for ACM and APC that allow a radio to determine an achievable TS and sends it to its link partner can modified to allow for different methods due to the protocol being used (including changes to ITCnet). This may require the addition of a method to exchange ACM and APC information. This would, for example, to allow for backward compatibility with deployed radios, additional packet types (or changes to existing packet types) could be deployed to allow for exchanging ACM and APC related information. Below are representative examples of how this information can be exchanged as part of any of the methods described herein.

In a first example, ACM/APC information is included in a base beacon message. This information could include, for example, information (a value) indicating whether the base station transmitting the base beacon packet is ACM/APC capable, a maximum power that a remote can transmit, or both.

Another alternative is to place this information in a field added to one or more preexisting packet types used by the access scheme used by the wireless network for other purposes. In the example of the ITCnet protocol, the field could be appended to a packet such as the ACK packet However, appending a field would increase the length of a packet, which would require more time for a radio to transmit it. Depending on the length of the field, the duration of a slot in which such a packet can be transmitted—the DTMA slot unit (DSU) and/or FTMSA slot unit (FSU) in the ITCnet access scheme—might not be long enough and thus might need to be extended. Other examples include appending a field to unicast data packet, such as the UCM packet in ITCnet, or to a control packet.

Alternatively, a new control packet, for example a transmission scheme (TS) control packet transmitted by a base station could be used. The appended files for a TS control packet could include any one or more of the following: a remote ID (for each remote that has a TS change) and a TS assigned to the remote. This packet would be, for example, sent at a predefined default rate. In ITCnet, it could be sent in the B-TX slot following the control packet. Alternatively, these fields could be appended to an existing base station control packet. However, the use of a TS control packet avoids problems with backward compatibility.

An alternative to appending a field to an ACK or unicast packet that would make not backward compatible with deployed radios that are not updated or updatable, is to use a new packet type to carry the TS indication. This would be an informational packet type rather than a control packet type. Note that they could be same format and hence a single control packet type

Another alternative is a layer 3 message type that carries the list of transmission schemes that is used at the radio that sent the message. The message could be sent between radios that are ACM capable when they initially connect to each other. The use of a message with a list of transmission schemes provides the ability to use different transmission schemes at different radios. The message would be sent at the default rate.

In ITCnet, the default time slot for the FSU, DSU, CDMA slot units (CSU) may optionally be changed to 1-ms unit reduces the time allocated for packet transmission and thereby increases the capacity. The time units for CGR would be designed for full/half rate and original control packet sizes. Because NGR with ACM will be able to support various rates, the use of 1-ms time unit for FSU, DSU, and CSU for all packet types will be advantageous.

The ACM/APC is applied to unicast communications between radios. This includes unicast traffic between base and remotes in DTDMA of the local channel and unicast traffic between remotes in DirectRF channels. The radio can be a base or remote radio. The link partner of the base radio is the remote radio that connects to the base. The link partner of the remote radio can be the base radio that it connects to or another remote radio (communication in DirectRF channel).

The following is a representative embodiments and examples of methods for ACM and APC in a wireless network such as ITCnet.

When two radios initially connect to each other, the radios exchange and agree on the set of TSs to be used for communications between the radios. After initial connection, each radio sends TS indication to the other radio, its link partner, when the radio has an updated TS indication. Specifically, when the radio receives an addressed packet from the link partner, the radio estimates the link quality determines the TS indication based on the estimated link quality and sends the TS indication to the link partner. In case that the TS indication is in form of achievable TS, the radio determines the achievable TS from the estimated link quality and sends it to the link partner. When the radio has an addressed packet to transmit to the link partner, the radio uses the received TS indication to decide which TS to be used for transmission.

One or more methods for measuring and estimating the link quality may be used. One method to estimate the link quality and determine the TS is based on average received signal to noise ratio (SNR) as a baseline.

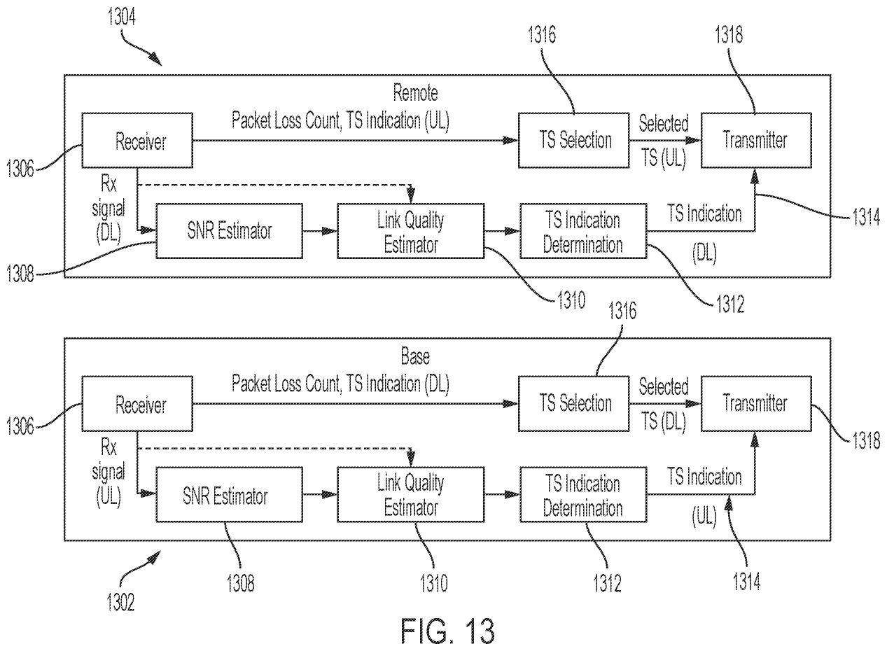

FIG. 13 is a schematic representation of the basic elements of a base station radio 1302 and a remote radio 1304 that are used to provide adaptive coding and modulation and adaptive power control for the radios. (They are not complete schematic diagrams for the radios.) The base station radio 1302 and the remote radio 1304 each have a receiver 1306, a SNR estimator 1308, a link quality estimator 1310, and a TS indication determination logic or module 1312 for determining or deciding on a transmission scheme and produces a signal or value representing a TS indication 1314. The receivers may be implemented as software defined radios using, for example, gate array or digital signal processor. Each of the modules may be implemented as programmed processes or logic using gate arrays, digital signal processors, general-purpose processors, or a combination of them. The use of the same reference number for the modules or other elements of the base and remote radios does not imply that hardware and software for an element are the same or need to be the same in each radio. The elements can be implemented differently in a base station radio and a remote radio. However, each would be configured or adapted to perform at least the methods described herein.

The SNR estimator 1308 estimates a received signal to noise ratio from a packet received by the receiver 1306. Its input is the received signal corresponding to the packet. Its output is an estimated SNR value. The link quality estimator 1310 estimates quality of the communication link from the link partner to the radio from the estimated SNR values—and optionally, other information that might be available concerning link quality—and provides an average SNR (or link quality indicator) to the link quality estimator 1310. TS indication determination logic or module 1312 determines a transmission scheme using (or in response to) the output of the link quality estimator 1310 and provides as an output the TS indication 1314. The TS indication can specify an achievable TS or be any one or more of other types of TS indications as discussed above. The TS Indication determined by a radio (radio A) indicates which of the allowed transmission schemes will have, based on the link quality estimate measured by radio A using a transmission from radio B to radio A, a desired margin on the channel link for a transmission from radio B to radio A link.

Each radio further includes a TS selection module 1316. The TS selection module for a given radio receives as an input the current transmission scheme used by the radio and TS indication from the radio of its link partner radio. This allows it to compare the TS indication from its link partner to the one it is currently using. In response to the radio calling on it to select a transmission scheme, it selects the transmission scheme based on at least these two inputs. It may also take into account additional information that the radio might have of the quality of the link, such as packet loss count. The packet loss count is, for example, the number of unsuccessfully transmitted packets based on the number the addressed packets sent to the link partner and not acknowledged by the link partner. A value or signal is provided to the transmitter 1318 that indicates to the transmitter the selected transmission scheme. The transmitter, in response configures itself to use the selected transmission scheme for the next transmission on the channel link.

Thus, for example, when an addressed packet is received at the radio, the SNR estimator estimates the received SNR from each packet received from the link partner. Next, the link quality estimator estimates the link quality from the received packets. In one example, the link quality estimator obtains an average SNR from the estimated SNR values. Then, the TS indication is determined from the average SNR based on the estimated link quality. In case the achievable TS is used as TS indication, it is the highest TS that the link partner can use for transmission while still meeting the link performance requirements. Once the TS indication is determined, the radio sends the TS indication to the link partner. When the radio has an addressed packet to transmit, the TS Selection module is called to select the TS for transmission. The TS selection takes the received TS indication and packet loss count as the inputs, selects the TS based on these inputs, and the outputs the selected TS which the radio will use for transmission. The received TS indication is what the radio receives from the link partner which is determined based on the quality of the link from the radio to the link partner.

Following are additional, representative examples of embodiments of methods of using ACM and APC with base station and remote radios of a wireless network for supporting messaging and communications in railroad applications. The example in context of a wireless network using ITCnet protocols but it can be adapted for other protocols. The methods may also be modified by the options disclosed above.

The process assumes that the base station is capable of ACM and/or APC, and the base station has indicated this to remote radios that might connect to it, such as by use of a broadcasted beacon message will include information on ACM/APC. This information may include, for example, an indication that the base is ACM/APC capable. If the base station is APC capable, the base stations' beacon may include the maximum power level at which a remote communicating with it may transmit. A packet transmitted by the remote radio to the base station, such as a packet to initiate a connection with the base station radio—an acquire packet (ACQ) in ITCnet—indicates whether the remote radio is ACM and/or APC capable. The base station radio has a preconfigured or predetermined set of transmission schemes that is supports and that the remote radio also has a set transmission schemes that supports, which it sends to the base station when the remote connects to it. The base station determines which set of transmission schemes will be used on the link between the base station and the remote, and then sends this information to the remote. This ensures that any a selected transmission scheme is known by both the base station and the remote and is supported by both. However, other methods can be substituted or used in addition to this method to agree to a list of allowed transmission schemes.

More specifically for a wireless network using ITCnet protocol or one substantially similar to relevant aspects, a base station periodically broadcasts a base station beacon. The base beacon of the station advertises that it has ACM and/or APC capability using an indication ion the massages. A remote radio listening for base station beacons decides to connect to the base station. If either the radio of the base station or the remote does not have ACM or APC capability, ACM and/or APC is not used for the channel link. More specifically, if the remote does not have ACM/APC capability and receives a base beacon with ACM/APC information, it will not process the ACM/APC information in the base beacon. To initiate the connection, it will send an ACQ to the base station without an indication that the remote is ACM or APC capable. The base station will note this and uses standard communication procedures or CGR with the remote. If the remote has ACM/APC capabilities but the base does not advertise these capabilities, the remote stores information that the base station does not have this capability and uses CGR procedures or standard communications schemes with the base station.

If the remote radio is ACM and/or APC capable, it will store information that the base station radio is ACM/APC capable, and the allowed maximum power level included in the base beacon. The remote sets the maximum transmit power for all communications under the base to within the allowed maximum power level: Pmax=min (Pmax_remote, Pmax_allowed). Pmax is the maximum power that the radio uses for transmission; Pmax_remote is the maximum power that the remote can transmit (based on the radio specifications); and Pmax_allowed is the maximum power that is allowed (e.g., based on regulations). The remote radio sends an ACQ packet to the base station. The ACQ includes indication that the remote radio is ACM/APC capable.

The base station and remote radios then exchange messages to agree on the set of transmission schemes that can be used. After the remote radio and base station radio have stored the same set of selected or allowed transmission schemes, each selects the most reliable TS in the set as the default transmission scheme (TS_Default). The reliability of each transmission scheme is known.

The process agreeing on allowed transmission schemes is done after the base station receives ACQ from the remote to connect to the base station. This can be done, for example, using the following method.

First, the base station assigns a slot to the remote radio. The remote radio sends a packet carrying the set of transmission schemes that it can support to the base station. If the base station receives the packet, the base station acknowledges it in the next control frame. Otherwise, the base station assigns another slot to the remote radio. If the remote radio does not receive the acknowledgement, it tries to retransmit the packet.

Once base station receives the set of transmission schemes from the remote radio, the base station determines which transmission schemes to be used between the base station and the remote radio. One option is to choose all the base station transmission schemes that are also supported at the remote radio.

The base station sends a packet with the set of selected transmission schemes to the remote radio in a DTDMA B-TX slot. The remote radio records the set of transmission schemes and acknowledges the packet reception. If the base station receives the acknowledgement, the base station notes the set of selected transmission schemes for the remote radio. Otherwise, the base station resends the packet in the next DTDMA cycle.

The following is applicable both communications between a base station radio and a remote radio and communications between remotes. The radio in the description below can be a base or a remote radio.

Some of ACM/APC methods described below are implemented in each radio, whether it is a base station or a remote, and thus may apply to communications between a base station radio and a remote radio and to communications between remote radios. If reference is made to just “radio” it can be a base station or a remote radio. (1) Set the Current TS to the default TS: TS_Default. (2) When an addressed packet is received from the link partner, (a) estimate the link quality, quality of the communication link from the link partner to the radio; and (b) determine the TS indication (call the TS Indication Determination module) and queue the TS indication. The queue is one deep; overwrite anything previously queued. In case that the achievable TS is used for TS indication, determine the achievable TS, and queue the achievable TS. (3) If there is a TS indication in the received packet, extract the TS indication. Overwrite any previously received TS indication. This is the TS indication for the link from the radio to the link partner.

When an addressed packet is to be transmitted to radio of the link partner, the following method can be used. (1) Select the TS (call the TS Selection module). Set the Current TS to the Selected TS. (2) If the TS indication has been queued and it can be carried by the packet, include the TS indication. (3) Transmit the packet, using the Current TS.

When a radio has an updated TS indication in the queue, the radio should try to deliver the TS indication as soon as it can. After the TS indication is successfully transmitted (for example an ACK packet or response is received), the radio removes it from the queue.

When a remote radio has a TS indication to deliver, an example of a method for delivering is the following method. (1) Append the TS indication to a UCM packet if there is one pending for the intended destination. (2) Otherwise append the TS indication to an ACK packet if there is one pending. (3) Otherwise send a TS indication packet at the first opportunity. For communication between base and remote, this can be sent in CSMA slots rather than sending QSTAT just to request time for this packet which is shorter. Sending TS indication in the response to the UCMs that the radio receives from the link partner can be the most efficient means of sending this information if the link partner is sending UCMs to the remote. Therefore, it should be done every time a UCM is received.

When a base has the TS indication to deliver, it may: (1) Append the TS indication to a UCM packet if there is one pending for the intended destination. (2) Otherwise append the TS indication to a CTL packet that includes a slot assignment for the intended remote if one is pending. (3) Otherwise send a TS indication packet in the B-Tx section of a DTDMA cycle.

When implementing ACM and APC protocols in a wireless network using ITCnet protocols, the schedules for communications between a base station and a remote in local channels and the scheduling for access to the local channel may, optionally, be adjusted for the base and remotes that are ACM/APC capable. More time may need to be allowed for an additional field carrying TS indication in ACK and UCM packets. Since these slots are quantized to a given length of time—4 ms in ITCnet—additional time may not be required. However, to fit the packet with the TS indication information into one slot, the size of the allocated slots could be varied based on the TS indication being sent by the remote radio. For example, if the base has sent TS indication that indicates a lower or slower transmission scheme, the base system begins to allocate longer slots. However, if the base radio sends TS indication that indicates a higher or faster transmission scheme, the base radio should not change to allocating shorter slots until it detects that the remote radio has sent packets using the higher or faster transmission scheme. Furthermore, if the time since the last successful slot allocation by the based radio to the remote radio has exceeded some threshold (approximately equal to the timeout for automatic downgrade), the base start to allocate longer slots for allowing for downgrading to a slower transmission scheme. If the remote radio responds to an allocation message that increases the length of the allocated slots without changing the transmission scheme, the base station will, optionally, revert to the previous slot sizing.

Described below is an example of a method for estimating SNR that may be used by a base station radio and a remote radio. In this example, interference is not distinguished from the noise. When the interference exists, the algorithm provides an estimate of the received signal to noise and interference ratio (SINR).

In ITCnet protocol, there are several broadcast packets from the base that can be used by remote to estimate the link quality. These packets include any one or more of the following packet types. A first type of broadcast packet that may be used is the Base DSB (dynamic short broadcast) control packet, which base radio broadcasts at the beginning of every DSB cycles. The base DSB control packet is transmitted at a default data rate. A second one the Base DTDMA control packet, which the base station radio broadcasts at the beginning of every DTDMA cycles. The base DTDMA control packet is transmitted at a default data rate. Please refer to the access scheme that is shown and described in connection with FIGS. 2A, 2B, 2C and 3 for details about the cycles. A third type is the Base Beacon. The base station radio broadcasts it periodically at a predetermined, usually configurable, time interval.

In addition to broadcast packets, the remote can utilize also one or more of the unicast packets that the base station radio sends directly to the remote to estimate the quality of the communication link. The unicast packet is sent in the Base Tx part of the DTDMA cycle.

At the base station, the base station radio can utilize any one or more of the types of packets that the base station radio receives from the remote radio to estimate the received SNR. These includes unicast data packets from and other types of ITCnet packets such as QSTAT, ACQ, and ACK.

An objective of the SNR estimation algorithm is to output a value that reasonably accurately reflects the average SNR (the noise level, relative to the average received signal level) regardless of the channel conditions. Ideally, the presence of amplitude and phase distortion caused by fading channels should have no effect on the estimated SNR value. In order to make the estimation algorithm insensitive to fading, the method may estimate and remove the amplitude and phase distortion.

The SNR estimation is, one embodiment, done at the baseband level. The radio receives signal, processes through RF chain, down-converts the processed signal to baseband, and then performs SNR estimation method using, for example, programmed gate array or executed by digital signal processor, or central processing unit. The SNR estimation algorithm can be done by first removing the phase distortion, next removing the amplitude distortion, and then estimating the SNR which can be obtained using mean square error estimation. After the remote radio estimates the SNR of the received packet, it stores the estimated SNR value for further calculation of SNR average. A detailed SNR estimation algorithm and performance analysis is provided in the appendix.

As already mentioned, each remote estimates the quality of communication link between the remote and its connected base by utilizing packets that the base transmits in the local channel. Similarly, the base station radio also estimates the quality of communication link between the base and each connected remote by utilizing packets that base receives from the remote in the local channel.

There are different ways to measure and estimate the link quality. In one example of a method for measuring and estimating link quality, the method estimates the link quality from an average SNR. The link quality estimation may, optionally, be further improved by taking into account additional information such as packet error rate (PER), or distance between base and remote, or both.

For communications between base and remote, at the remote radio, an average SNR is determined for the downlink from to the remote from its connected base. At the base radio, the average SNRs are determined for the uplink from each connected remote to the base. For communications between remotes in the DirectRF channels, at each remote radio, the average SNR is determined for the communication link from the link partner to the remote.

For each packet received from the link partner, the radio estimates the SNR value of the received signal, using a method such as the one described above. Then, the radio determines the average SNR by averaging the estimated SNR values from multiple received packets.

To obtain SNR average, the radio performs moving average of the estimated SNR values. The SNR estimate preferably includes packets of nonvarying length, such as CTL packets However, it may also include packets of variable length, such as UCMs, using only the header part of the packet. APC does not have a significant impact on the SNR estimate because the power is only adjusted when the radio operates at the highest data rate. The radio averages the estimated SNR values over a time period, T. The time window T is configurable and can be adjusted to optimize the estimation test data. The default time window is set to a predetermined interval, such as 8 seconds which is equivalent to 2 ITCnet superframes.

The SNR average may be determined by equally averaging the estimated SNR values for the packets received during the time window. Further optimization can be done in the future for example by using weighted average, low pass filter, etc. The averaging process receives the estimated SNR values as the inputs and provides the average SNR as the output.

The average SNR at time t is obtained as follows. (1) Count the number of estimated SNR values of the desired link within T seconds from (t−T) to t seconds. Let N_{T} be the number of estimated SNR values. (2) Determine the average SNR if there are a sufficient number of estimated SNR values. If N_{T}<N_{T} min, end the algorithm. No valid average SNR is provided. Otherwise, continue to Step 3. (3) Determine the average SNR according to the following equation

$$S N {R}_{AVG} \_dB = \frac{1}{{N}_{T}} {\sum }_{i = 1}^{{N}_{T}} {SNR}_{i} \_dB \qquad Equation 2$$

where SNRᵢ_dB is the i^{th} estimated SNR value in dB.

Note that N_{T} depends on how many packets the radio receives during T seconds, and it can be different for each T-second window. The SNR_{AVG}_dB is considered valid when N_{T} is at least N_{T}_min. The N_{T}_min is configurable, and the default value is 2. N_{T}_min will be periodically updated when internal test data and/or field test data are available. The update N_{T}_min will be included in subsequent specification releases when applicable.

The average SNR can be used in a method that determines an Achievable Transmission Scheme. In an example of the method First, a data rate is selected as the maximum rate that can be achieved while still meeting the link performance requirement. Next, if the power control is enabled and the radio can transmit at highest data rate with lower transmit power and still meet the link performance requirement, a transmission scheme with a lower than full transmit power is selected. Thus, the TS determination method takes the average SNR as the input and provides achievable TS as the output. The method is as follows. (1) Note the average SNR, SNR_{AVG}_dB; (2) Determine the achievable rate if the average SNR is valid. (2)(a) If the average SNR is valid, the achievable rate is the maximum rate that can be achieved:

R=max Rᵢ, ∀Rᵢ with SNR_dB(Rᵢ)<SNR_{AVG}_dB

(2)(b) Otherwise, end the algorithm. No achievable TS is provided. (3) Select full transmit power if APC is disabled. (3)(a) If APC is disabled, select the full transmit power P=Pmax, and go to Step 5; (3)(b) otherwise, proceed to Step 4 to determine the achievable power. (4) Determine the achievable power if APC is enabled. (4)(a) If the achievable rate is less than highest data rate, select the full transmit power: P=Pmax; (4)(b) If the achievable data rate is the highest data rate (R=Rmax), check if the SNR is more than the SNR threshold plus margin and determine the transmit power accordingly. The margin is configurable. The default margin is 3 dB. (4)(b)(i) If the SNR is not more than the SNR threshold plus margin, select the full power: P=Pmax. (4)(b)(ii) Otherwise, the transmit power can be lower by the following PowerAdjust: if R<Rmax, PowerAdjust=0; else PowerAdjust=SNR_{AVG}_dB−SNR_dB(Rmax)−margin. Select the power P=Pmax−kΔP where ΔP is the power adjustment step and k is the maximum integer that kΔP is less than PowerAdjust. (5) Output the achievable TS corresponding to achievable rate R and transmit power P. The power adjustment step ΔP is a configurable parameter that can be adjusted based on internal and field testing.

To support train control, the performance requirement of communication links between a base station radio and a remote radio is set at 90% success transmission rate, which is equivalent to 10% packet error rate. In PTC, it is also required that the communication system needs to support train speed up to 160 mph.

Taking into account the requirements on packet success rate and train speed, the data rates and corresponding required SNRs are then determined based on transmit and receive performance over fading channel. Using field test and/or simulation test data, data rates and a required SNR to maintain the same packet success rate performance for each transmission are determined and put into a table, such as the example shown in Table 9. The required SNR preferably includes margin to accounts implementation lost and estimate error that could happen in the actual operation.

TABLE 9

| | | | Single | With | |
|---|---|---|---|---|---|
| Data Rate | | Coding | Antenna | Diversity | PAPR |
| (kbps) | Modulation | Rate | SNR (dB) | SNR (dB) | (dB) |
| 24 | DQPSK | 3/4 | 19 | 12 | 3.8 |
| 28 | DQPSK | 7/8 | 20 | 13 | 3.8 |
| 36 | D8PSK | 3/4 | 24 | 19 | 4.3 |
| 42 | D8PSK | 7/8 | 27 | 21 | 4.3 |
| 48 | 16DAPSK | 3/4 | 30 | 24 | 5.5 |
| 56 | 16DAPSK | 7/8 | 33 | 27 | 5.5 |

PAPR is Peak to Average Power Ratio and is obtained from the lab measurements.

The method of selecting a transmission scheme applies to both base and remote radios. A software implemented process is called to run on a processor at the radio when the radio has an addressed packet to transmit to its link partner. The radio selects which TS to be used based on TS indication that the radio previously received the link partner. The radio may also consider a packet loss count in making the decision. In one embodiment of the method, when the link is good, the TS is slowly increased one step at a time from the default TS. The TS selected by the radio cannot be higher than the achievable TS. The default TS is the most reliable TS. The method also returns to the default TS when no packet is received for a predetermined or set period of time and/or when packets transmitted at higher TS are not successfully delivered for N consecutive packets. An example of a default value for N is 2. However, it is, optionally, a configurable parameter, as are also the time periods. The radio optionally keeps track of packet loss for unicast traffic sending to the link partner. In ITCnet, for example, the packet loss count is taken into account during TS section for packets transmitted in the B-TX and R-TX sections but not the CSMA sections of DTDMA cycles. Initially, the packet loss count is 0. After a radio transmits an addressed packet, if the packet is acknowledged (e.g., an ACK or response is received), the radio resets the packet loss count to 0. Otherwise, it increases the packet loss count by one.

Following is a non-limiting representative example of a transmission scheme (TS) selection method can be used one either or both base and remote radios. The TS selection algorithm takes TS indication and current TS as the inputs and select which TS should be used. The TS Selection algorithm outputs the selected TS. The algorithm is called when a radio has an addressed packet to transmit. If more than N consecutive packets are lost, select the default TS: TSselect=TSdefault. Otherwise, if no TS indication is received for a predetermined or configured time, select the default TS by setting the value of TSselect to TSdefault. Otherwise, store the TS indication received from the link partner. The method also stores the current TS, TScurrent, which is the TS that the radio is using. In case that TS indication is the achievable TS, TSachiev, the method selects the TS as follows: If TScurrent<TSachiev, the selected TS is one step higher than the current TS: TSselect=TScurrent+1. If TScurrent>=TSachiev, the selected TS is the same as the achievable TS: TSselect=TSachiev.

The selection criteria above can be adjusted if another parameter is used as TS indication. The output of the method is the selected TS.

An example of an SNR Estimation method for estimating the received signal to noise ratio (SNR) from the received π/4-DQPSK symbols is given below. The estimation algorithm is blind in the sense that it does not require prior knowledge of the modulating data; it does not need to know the preamble bit-pattern, or the header information, and it does not need the presence of any known pilot symbols etc. In addition, the method is able to provide accurate results over a wide range of channel conditions, including AWGN, and frequency-flat fading.

To make the estimation algorithm insensitive to fading, the algorithm needs to estimate and remove the amplitude and phase distortion. The following steps are performed; a) remove the phase distortion, b) remove the amplitude distortion, c) estimate the SNR.

To remove phase distortion after down-conversion to baseband, the received symbols go through several signal transformations. The first one produces from a sequence of received symbols a sequence of QPSK symbols scaled by the channel fading amplitude. The differential demodulation removes (or reduces to something very small) the random phase of the channel, and all that remains is the amplitude fading and (although not included in the above equations) noise.

The transformation is described by the following equation, where Aₙ and ϕₙ are the channel amplitude and phase, respectively, at symbol index n:

yₙ=e^{jϕ}^{ₙ}(Aₙ₊₁Aₙ) for n=0 to N−1 Equation 3

where θₙ is one of four possible phases, corresponding to the π/4-DQPSK signal alphabet:

$${ϕ}_{n} = \pm \frac{π}{4} , \pm \frac{3 π}{4} \qquad Equation 4$$

Once the channel phase is removed, the next step is to separate out the amplitude fading component from the random noise. Since the SNR estimation method does not know the data modulation, the underlying data is removed by folding the signal constellation so that all of the received symbols occupy the top RHS quadrant. This is achieved by converting all of the I and Q components into positive values (removing the negative signs):

zₙ=abs(real(yₙ))+j×abs(imag(yₙ)) Equation 5

where y is the differentially demodulated symbols described in the previous section and the resulting symbols are z. The next step is to rotate the folded-over the symbols by 45 degrees, so that the centroid of the received symbols lies on the real (I) axis. The phase rotation is achieved by the performing following complex-valued multiplication for each output symbol from equation 5.

zₙ′=zₙe^{-jπ/4} Equation 6

The fading component is then moved to the real axis (the in-phase component), and the imaginary axis (the Q component) contains only noise.

The next step is to normalize the signal level so that the average of the inphase (I) component is scaled to a value of unity. This normalization step makes the SNR estimation algorithm able to operate over a wide range of signal levels. The mean of the I component (equal to unity after the normalization step) is then subtracted out, so that the received symbol “cloud” is centered at the origin (I,Q=0,0). The normalization and translation to (0,0) is performed as follows:

$${z}_{n}^{″} = \frac{{z}_{n}^{′}}{\frac{1}{K} {\sum }_{k = 0}^{K - 1} r e al ( {z}_{k}^{′} )} - 1 \qquad Equation 7$$

where n is the symbol index, and K is the total number of symbols. By discarding the I component from the symbols z″, the fading is removed and all that remains is the noise on the Q component:

zₙ′″=imag(zₙ″) Equation 8

After completing the various signal transformations described above, the signal that remains is zero-mean with variance equal to the variance of the received noise. The mean-squared error is estimated as follows:

$$M S E = \frac{1}{N} {\sum }_{n = 0}^{N - 1} {( {z}_{n}^{′′′} )}^{2} \qquad Equation 9$$

The output is then converted to SNR in decibels (dBs):

SNR_{dB}=10 log₁₀(1/MSE) Equation 10

which is equivalent to:

SNR_{dB}=−10 log₁₀(MSE) Equation 11

The foregoing description is of exemplary and preferred embodiments. The invention, as defined by the appended claims, is not limited to the described embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated or described structures or embodiments.

1. A method for adapting one or more transmission parameters to transmit packets containing data for train control over a wireless link between a first radio and a second radio in a wireless network supporting positive train control, comprising:
estimating with the first radio a link quality metric for the wireless link based on packets received by the first radio from the second radio over the wireless link;
determining with the first radio a data rate for transmitting data over the wireless link to the second radio, wherein determining the data rate comprises selecting a transmit data rate from a plurality of predetermined data rates based on the link quality metric for the wireless link, each of the plurality of predetermined data rates having a corresponding predetermined modulation and coding scheme capable of transmitting data at the predetermined data rate over a wireless link having the estimated link quality metric while meeting at least one or more predefined performance metrics; and
transmitting with the first radio a packet comprised of at least a header portion and a payload portion over the link to the second radio, the payload portion being transmitted at the transmit data rate using the predetermined modulation and coding scheme corresponding to the transmit data rate.

2. The method of claim 1 wherein the link quality metric is a signal to noise ratio.

3. The method of claim 1, wherein the at least one or more predefined performance metrics comprises a maximum error rate.

4. The method of claim 1, wherein the header portion is transmitted at a default rate.

5. The method of claim 1, wherein the first radio is a remote radio and the second radio is a base station radio, the base station radio controlling the use of a local channel of the wireless network in a geographic area covered by the base station.

6. The method of claim 5, wherein the base station radio controls access to the local channel with a predetermined multiple access scheme, the base station radio allocating slots to remote radios using the local channel for transmitting packets containing data.

7. The method of claim 5, wherein the remote radio estimates the link quality metric using unicast or broadest transmissions of the base station over a period of time.

8. The method of claim 7, wherein the period of time comprises a sliding window of time.

9. The method of claim 7, wherein the link quality metric is an average of estimates of the link quality metric made over the period of time.

10. The method of claim 1, wherein transmitting the determined data rate to the second radio by the first radio at a default data rate comprises transmitting the determined data rate in a control packet requesting the second radio to allocate to the first radio a transmission slot in a multiple access scheme for a local channel used by the link to transmit train control data.

11. The method of claim 1, further comprising determining with the first radio a transmit power for the link, the transmit power being set equal to a default transmit power or, if the estimated link quality metric exceeds the link quality metric required for selecting a highest data rate among the predetermined data rates, to a lower transmit power that allows for the transmission of data over the link at the highest data rate while meeting the one or more predetermined performance metrics.

12. The method of claim 11 wherein transmitting over the link a packet containing the determined data rate from the first radio to the second radio further comprises including in the packet the transmit power determined with the first radio.

13. The method of claim 11 wherein transmitting over the link a packet containing the determined data rate from the first radio to the second radio further comprises including in the packet an indication of the transmit power determined with the first radio.

14. A remote radio for transmitting real time application messages from a base station radio of a wireless network capable of supporting positive train control, comprising:
a receiver for receiving packets transmitted over a wireless link from a base station radio, the receiver configured for receiving, demodulating, and decoding wireless data packets sent with any one of a plurality of predetermined transmission schemes, the plurality of predetermined transmission schemes including a default transmission scheme and one or more faster transmission scheme for transmitting at higher data rates;
a transmitter configured to adapt dynamically the transmission scheme with which it transmits data over the wireless link wireless packets containing positive train control messages;
means for estimating a link quality metric for the wireless link based on packets received by the receiver and selecting based on at least the estimated link quality metric one of the plurality of predetermined transmission schemes for transmitting a payload of a wireless packet, the selected transmission scheme being capable of transmitting data at a faster data rate while meeting one or more predefined performance metrics established for transmitting real time application message data; and
means for adapting the transmitter to transmit at least a payload portion of the wireless packet over the wireless link with the selected transmission scheme.

15. The radio of claim 14 wherein the link quality metric is a signal to noise ratio.

16. The method of claim 14, wherein the at least one or more predefined performance metrics comprises a maximum error rate.

17. The radio of claim 14, wherein a header portion of the wireless packet is transmitted using the default transmission scheme.

18. The Radio of claim 14, wherein the means for estimating a link quality metric for the wireless link estimates the link quality metric using unicast or broadest transmissions from a base station over the wireless link received by the receiver over a preceding period of time.
